(19) United States
(12) Patent Application Publication
(10) Pub. No.: US 2020/0047747 A1
(43) Pub. Date: Feb. 13, 2020

(54) VEHICLE AND CONTROL METHOD THEREOF

(71) Applicants: HYUNDAI MOTOR COMPANY, Seoul (KR); KIA MOTORS CORPORATION, Seoul (KR)

(72) Inventors: Daeyun An, Anyang-si (KR); Dong-Seon Chang, seong-si (KR); Seunghyun Woo, Seoul (KR)

(73) Assignees: HYUNDAI MOTOR COMPANY, Seoul (KR); KIA MOTORS CORPORATION, Seoul (KR)

(21) Appl. No.: 16/211,637

(22) Filed: Dec. 6, 2018

(30) Foreign Application Priority Data
Aug. 10, 2018 (KR) 10-2018-0093472

(51) Int. Cl. B60W 30/09; G08G 1/16; B60W 30/095; B60W 40/09; G06K 9/00; G05D 1/02

(52) U.S. Cl. CPC B60W 30/09; G08G 1/166; G08G 1/167; B60W 30/0956; B60W 30/0953; G05D 2201/0213; G06K 9/00805; G06K 9/00369; G06K 9/00348; G05D 1/0246; B60W 2420/42; B60W 40/09

(57) ABSTRACT

A vehicle and a control method thereof are provided to predict a behavior of a driver and a pedestrian and control the vehicle based on the predicted behavior of the driver and the pedestrian. The vehicle includes a capturer configured to capture an image around the vehicle; a behavior predictor configured to obtain joint image information corresponding to the joint motions of a pedestrian based on the captured image around the vehicle, predict behavior change of the pedestrian based on the joint image information, and determine the possibility of collision with the pedestrian based on the behavior change; and a vehicle controller configured to control at least one of stopping, decelerating and lane changing of the vehicle so as to avoid collision with the pedestrian when there is a possibility of collision with the pedestrian.

### CROSS-REFERENCE TO RELATED APPLICATION

The present application claims priority to and the benefit of Korean Patent Application No. 10-2018-0093472, filed on Aug. 10, 2018, which is incorporated by reference in its entirety.

### TECHNICAL FIELD

Embodiments of the present disclosure relate to a vehicle and a control method thereof for predicting a behavior of a driver and a pedestrian.

### BACKGROUND

The statements in this section merely provide background information related to the present disclosure and may not constitute prior art.

In modern society, vehicles are the most common means of transportation and the number of people using vehicles is ever increasing.

In recent years, studies on vehicles equipped with an Advanced Driver Assist System (ADAS) that actively provides information about the state of the vehicle, a driver's condition, and the surrounding environment in order to reduce the burden on the driver and enhance convenience are actively proceeding.

### SUMMARY

An aspect of the present disclosure is to provide a vehicle and a control method thereof, for predicting a behavior of a driver and a pedestrian and controlling the vehicle based on the predicted behavior of the driver and the pedestrian.

Additional aspects of the disclosure will be set forth in part in the description which follows and, in part, will be obvious from the description, or may be learned by practice of the disclosure.

In accordance with an aspect of the present disclosure, a vehicle includes: a capturer configured to capture an image around the vehicle; a behavior predictor configured to obtain joint image information corresponding to the joint motions of a pedestrian based on the captured image around the vehicle, predict behavior change of the pedestrian based on the joint image information, and determine the possibility of collision with the pedestrian based on the behavior change; and a vehicle controller configured to control at least one of stopping, decelerating and lane changing of the vehicle so as to avoid collision with the pedestrian when there is a possibility of collision with the pedestrian.

The capturer may capture a three-dimensional (3D) vehicle periphery image.

The behavior predictor may transmit a vehicle control signal to the vehicle controller when there is a possibility of collision with the pedestrian.

The vehicle may further include: a situation recognizer configured to recognize the surrounding situation of the vehicle based on the image around the vehicle, determine whether or not the pedestrian is possibly in the view based on the surrounding situation of the vehicle, and output a trigger signal so that the behavior predictor obtains the joint image information when the pedestrian is in the view.

The behavior predictor may obtain the joint image information based on the image of the pedestrian located closest to a driving road of the vehicle among a plurality of pedestrians when the pedestrians appear in the vehicle periphery image.

The joint image information may include lower body image information about the lower body of the pedestrian. The behavior predictor may predict the behavior change of the pedestrian based on the lower body image information.

The vehicle may further include: a learning machine configured to learn the next behavior of the pedestrian in a previous driving according to a change of the joint features of the pedestrian in the previous driving using a machine learning algorithm and generate learning information capable of predicting the next behavior of the pedestrian according to the change of the joint features of the pedestrian. The joint features may include at least one of an angle of the joints and a position of the joints.

The behavior predictor may calculate the joint features of the pedestrian based on the joint image information and obtain current behavior information indicating the current behavior of the pedestrian based on the joint features.

The behavior predictor may calculate a change of the joint features of the pedestrian based on the joint image information and obtain predictive behavior information indicating a predicted next behavior of the pedestrian after a certain point in time based on the change of the joint features and the learning information.

The behavior predictor may obtain behavior change prediction information indicating the behavior change of the pedestrian by comparing the current behavior information and the predictive behavior information.

The behavior predictor may predict whether or not the pedestrian will enter the driving road of the vehicle based on the behavior change prediction information and determine the possibility of collision with the pedestrian based on the vehicle driving information when the pedestrian is predicted to enter the driving road. The vehicle driving information may include at least one of a driving speed, an acceleration state, and a deceleration state.

The vehicle may further include: a speaker configured to output to the driver of the vehicle based on the control of the vehicle controller at least one of a warning sound and a voice guidance indicating that the pedestrian is predicted to enter the driving road.

The vehicle may further include: a display configured to display to the driver of the vehicle based on the control of the vehicle controller a warning indicating that the pedestrian is predicted to enter the driving road.

The vehicle may further include: a HUD configured to display on the front window to the driver of the vehicle based on the control of the vehicle controller at least one of a warning indicating that the pedestrian is predicted to enter the driving road and a silhouette of the pedestrian. The silhouette of the pedestrian may correspond to a predicted next behavior of the pedestrian after the certain point in time.

The HUD may display on the front window to the driver of the vehicle a plurality of silhouettes. Each of the plurality of silhouettes corresponds to a predicted next behavior of a corresponding one of pedestrians after the certain point in time.

In accordance with another aspect of the present disclosure, a vehicle includes: a capturer configured to capture an in-vehicle image; a behavior predictor configured to obtain joint image information corresponding to the joint motions of a driver based on the captured in-vehicle image, predict behavior change of the driver based on the joint image information, and determine the possibility of operation of the driver's brake pedal based on the behavior change; and a vehicle controller configured to control a brake system so that a brake can be operated simultaneously with the operation of the driver's brake pedal when there is a possibility of operation of the driver's brake pedal.

The behavior predictor may calculate the joint features of the driver and a change of the joint features based on the joint image information, obtain current behavior information indicating the current behavior of the driver based on the joint features, and obtain predictive behavior information indicating a predicted next behavior of the driver after a certain point in time based on the change of the joint features and learning information capable of predicting the next behavior of the driver according to the change of the joint features of the driver.

The behavior predictor may obtain behavior change prediction information indicating the behavior change of the driver by comparing the current behavior information and the predictive behavior information and determine the possibility of operation of the driver's brake pedal based on the behavior change prediction information.

In accordance with another aspect of the present disclosure, a vehicle control method includes: capturing an image around a vehicle; obtaining joint image information corresponding to the joint motions of a pedestrian based on the captured image around the vehicle; predicting behavior change of the pedestrian based on the joint image information; determining the possibility of collision with the pedestrian based on the behavior change; and controlling at least one of stopping, decelerating and lane changing of the vehicle so as to avoid collision with the pedestrian when there is a possibility of collision with the pedestrian.

The capturing of the image around the vehicle may include capturing a three-dimensional (3D) vehicle periphery image.

The method may further include: recognizing the surrounding situation of the vehicle based on the image around the vehicle; determining whether or not the pedestrian is possibly in the view based on the surrounding situation of the vehicle; and outputting a trigger signal to obtain the joint image information when the pedestrian is in the view.

The method may further include: obtaining the joint image information based on the image of the pedestrian located closest to a driving road of the vehicle among a plurality of pedestrians when the pedestrians appear in the vehicle periphery image.

The joint image information may include lower body image information about the lower body of the pedestrian. The method may further include: predicting the behavior change of the pedestrian based on the lower body image information.

The method may further include: learning the next behavior of the pedestrian in a previous driving according to a change of the joint features of the pedestrian in the previous driving using a machine learning algorithm; and generate learning information capable of predicting the next behavior of the pedestrian according to the change of the joint features of the pedestrian. The joint features comprise at least one of an angle of the joints and a position of the joints.

The method may further include: calculating the joint features of the pedestrian based on the joint image information; and obtaining current behavior information indicating the current behavior of the pedestrian based on the joint features.

The method may further include: calculating a change of the joint features of the pedestrian based on the joint image information; and obtaining predictive behavior information indicating a predicted next behavior of the pedestrian after a certain point in time based on the change of the joint features and the learning information.

The method may further include: obtaining behavior change prediction information indicating the behavior change of the pedestrian by comparing the current behavior information and the predictive behavior information.

The method may further include: predicting whether or not the pedestrian will enter the driving road of the vehicle based on the behavior change prediction information; and determining the possibility of collision with the pedestrian based on the vehicle driving information when the pedestrian is predicted to enter the driving road. The vehicle driving information comprises at least one of a driving speed, an acceleration state, and a deceleration state.

The method may further include: outputting to the driver of the vehicle at least one of a warning sound and a voice guidance indicating that the pedestrian is predicted to enter the driving road.

The method may further include: displaying to the driver of the vehicle a warning indicating that the pedestrian is predicted to enter the driving road.

The method may further include: displaying on the front window to the driver of the vehicle at least one of a warning indicating that the pedestrian is predicted to enter the driving road and a silhouette of the pedestrian. The silhouette of the pedestrian may correspond to a predicted next behavior of the pedestrian after the certain point in time.

The method may further include: displaying on the front window to the driver of the vehicle a plurality of silhouettes. Each of the plurality of silhouettes corresponds to a predicted next behavior of a corresponding one of pedestrians after the certain point in time.

In accordance with another aspect of the present disclosure, a vehicle control method includes: capturing an in-vehicle image; obtaining joint image information corresponding to the joint motions of a driver based on the captured in-vehicle image; predicting behavior change of the driver based on the joint image information; determining the possibility of operation of the driver's brake pedal based on the behavior change; and controlling a brake system so that a brake can be operated simultaneously with the operation of the driver's brake pedal when there is a possibility of operation of the driver's brake pedal.

The method may further include: calculating the joint features of the driver and a change of the joints feature based on the joint image information; obtaining current behavior information indicating the current behavior of the driver based on the joint features; and obtaining predictive behavior information indicating a predicted next behavior of the driver after a certain point in time based on the change of the joint features and learning information capable of predicting the next behavior of the driver according to the change of the joint features of the driver.

The method may further include: obtaining behavior change prediction information indicating the behavior change of the driver by comparing the current behavior information and the predictive behavior information; and determining the possibility of operation of the driver's brake pedal based on the behavior change prediction information.

Further areas of applicability will become apparent from the description provided herein. It should be understood that the description and specific examples are intended for purposes of illustration only and are not intended to limit the scope of the present disclosure.

### DRAWINGS

These and/or other aspects of the disclosure will become apparent and more readily appreciated from the following description of the embodiments, taken in conjunction with the accompanying drawings of which:

FIG. 1 is a perspective view schematically illustrating an appearance of a vehicle according to an embodiment;

FIG. 2 is a view illustrating the internal structure of a vehicle according to an embodiment;

FIG. 3 is a block diagram illustrating a vehicle according to an embodiment;

FIGS. 4A and 4B are conceptual diagrams illustrating a method for determining a pedestrian to be a target of behavior prediction when a plurality of pedestrians is recognized according to an embodiment;

FIGS. 5 and 6 are conceptual diagrams illustrating joint image information generated according to an embodiment;

FIGS. 7 to 9 are diagrams illustrating an example of a warning that a vehicle can output when a pedestrian enters a driving road according to an embodiment;

FIGS. 10A and 10B are diagrams illustrating a behavior of a driver when the driver operates an accelerator pedal or a brake pedal according to an embodiment;

FIG. 11 is a flowchart illustrating a method for starting behavioral prediction in a vehicle control method according to an embodiment;

FIG. 12 is a flowchart illustrating a method for predicting the next behavior of a pedestrian in a vehicle control method according to an embodiment;

FIG. 13 is a flowchart illustrating a method for controlling a vehicle based on a vehicle control signal in a vehicle control method according to an embodiment; and

FIG. 14 is a flowchart illustrating a method for controlling a vehicle through behavior prediction of a driver in a vehicle control method according to an embodiment.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Like numerals refer to like elements throughout the specification. Not all elements of the embodiments of the present disclosure will be described, and description of what are commonly known in the art or what overlap each other in the embodiments will be omitted. The terms as used throughout the specification, such as “˜part,” “˜module,” “˜member,” “˜block,” etc., may be implemented in software and/or hardware, and a plurality of “˜parts,” “˜modules,” “˜members,” or “˜blocks” may be implemented in a single element, or a single “˜part,” “˜module,” “˜member,” or “˜block” may include a plurality of elements.

It will be further understood that the term “connect” or its derivatives refer both to a direct and indirect connection, and the indirect connection includes a connection over a wireless communication network.

The terms “include (or including)” or “comprise (or comprising)” are inclusive or open-ended and do not exclude additional, unrecited elements or method steps, unless otherwise mentioned.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section.

It is to be understood that the singular forms “a,” “an,” and “the” include plural references unless the context clearly dictates otherwise.

Reference numerals used for method steps are merely used for convenience of explanation, but not to limit an order of the steps. Thus, unless the context clearly dictates otherwise, the written order may be practiced otherwise.

Hereinafter, an operation principle and embodiments of the present disclosure will be described with reference to accompanying drawings.

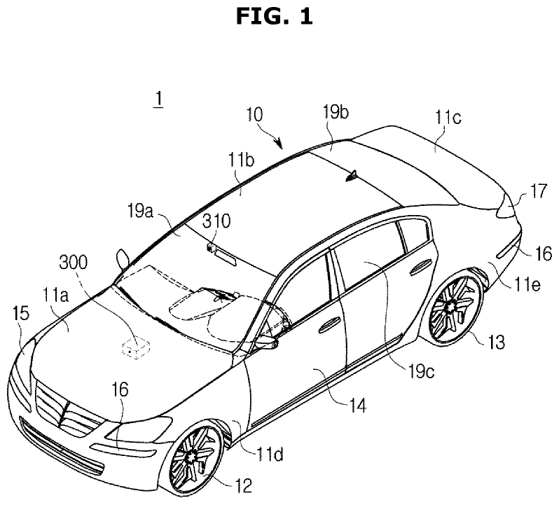

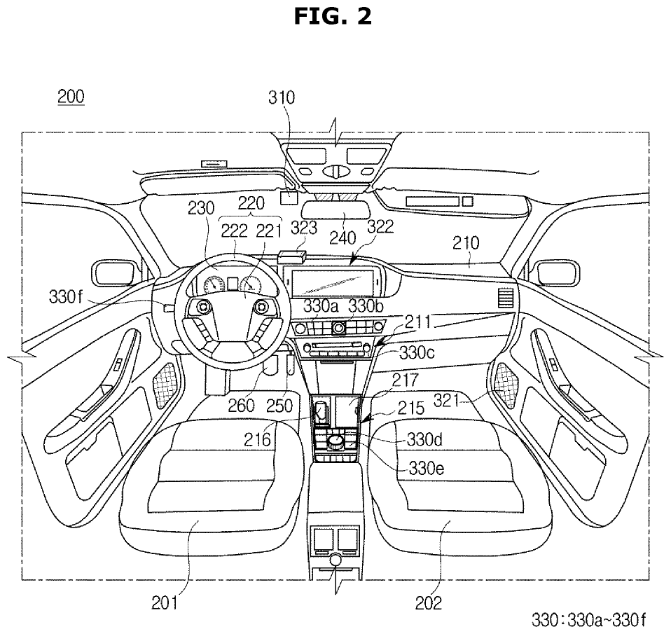

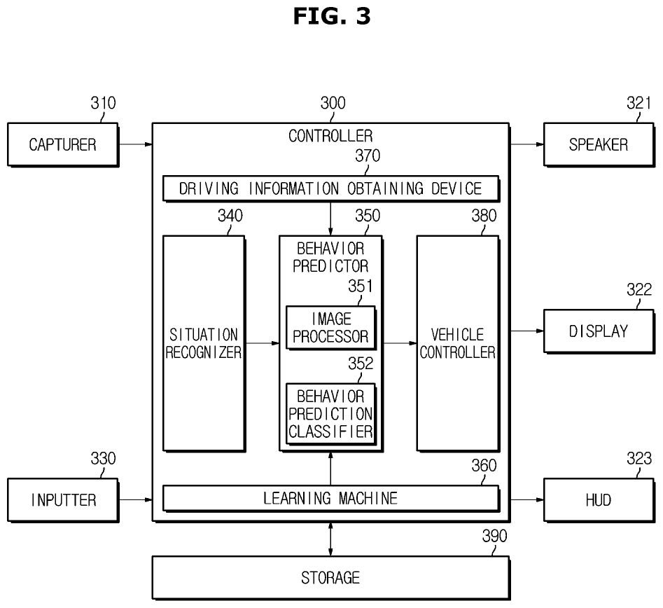

FIG. 1 is a perspective view schematically illustrating an appearance of a vehicle according to an embodiment, FIG. 2 is a view illustrating the internal structure of a vehicle according to an embodiment, and FIG. 3 is a block diagram illustrating a vehicle according to an embodiment.

Referring to FIG. 1, a vehicle 1 may include a vehicle body 10 that forms the exterior, and wheels 12 and 13 for moving the vehicle 1.

The vehicle body 10 may include a hood 11a for protecting various devices required for driving the vehicle 1, a roof panel 11b that forms an internal space, a trunk lid 11c of a trunk, front fenders 11d disposed on the sides of the vehicle 1, and quarter panels 11e. There may be a plurality of doors 14 disposed on the sides of the vehicle body 10 and hinged to the vehicle body 10.

A front window 19a is disposed between the hood 11a and the roof panel 11b for providing a view ahead of the vehicle 1, and a rear window 19b is disposed between the roof panel 11b and the trunk lid 11c for providing a view behind the vehicle 1. Side windows 19c may also be disposed at the upper part of the doors 14 to provide side views.

Headlamps 15 may be disposed at the front of the vehicle 1 for illuminating a direction in which the vehicle 1 drives.

Turn signal lamps 16 may also be disposed on the front and back of the vehicle 1 for indicating a direction in which the vehicle 1 will turn.

The vehicle 1 may blink the turn signal lamps 16 to indicate a turning direction. The turn signal lamps 16 may be provided both in front of and behind the vehicle 1. Tail lamps 17 may also be disposed at the back of the vehicle 1. The tail lamps 17 may indicate a state of gear shift, a state of brake operation of the vehicle 1, etc.

As illustrated in FIGS. 1 and 3, a capturer 310 may be provided in the vehicle 1. The capturer 310 may include at least one camera.

While the capturer 310 may be disposed around a mirror 240 of the vehicle (e.g., rearview mirror) in FIGS. 1 and 2, the location of the capturer 310 is not limited thereto, and may be disposed at any place in the vehicle that allows the capturer 310 to obtain image information by capturing an image of the inside or outside of the vehicle 1.

The capturer 310 may be configured to capture an image around the vehicle 1 while the vehicle 1 is being driven or stopped. In particular, the capturer 310 may capture a road on which the vehicle 1 is driving, a traffic light located on the vehicle driving path, a crosswalk, and the like, and may transmit the captured image to a controller 300.

The capturer 310 may capture the image of an object located inside or outside the vehicle 1 in real time by capturing the inside or outside of the vehicle 1.

In particular, when the object is a pedestrian, the capturer 310 may capture the image of the pedestrian around the vehicle in real time, and may transmit the image of the captured pedestrian to the controller 300.

In addition, when the object is a driver, the capturer 310 may capture the image of the driver in the vehicle 1 in real time, and may transmit the image of the captured driver to the controller 300.

As described above, the capturer 310 may include at least one camera, and further include a three-dimensional (3D) space recognition sensor, radar sensor, ultrasound sensor, etc., to capture a more accurate image.

For the 3D space recognition sensor, a KINECT (RGB-D sensor), TOF (Structured Light Sensor), stereo camera, or the like may be used, without being limited thereto, and any other device having a similar function may also be used.

In addition, the capturer 310 may capture the 3D vehicle periphery image and the in-vehicle image, obtain the 3D image information of the pedestrian based on the 3D vehicle periphery image, and obtain the 3D image information of the driver based on the 3D image in-vehicle information.

Referring to FIG. 2, a vehicle interior 200 may include a driver's seat 201, a passenger seat 202 adjacent to the driver's seat 201, a dashboard 210, a steering wheel 220, and an instrument panel 230.

The vehicle interior 200 may include an accelerator pedal 250 that is pressed by the driver according to the driver's acceleration intent and a brake pedal 260 that is pressed by the driver according to the driver's braking intent.

The dashboard 210 refers to a panel that separates the internal room from the engine room and that has various parts required for driving installed thereon. The dashboard 210 is disposed in front of the driver's seat 201 and the passenger seat 202. The dashboard 210 may include a top panel, a center fascia 211, a gear box 215, and the like.

A speaker 321 may be installed in the door 14 of the vehicle 1. The speaker 321 may warn the driver of the vehicle 1 that a pedestrian is predicted to enter the driving road. For example, the speaker 321 may output a warning sound of a different pattern indicating that a pedestrian is predicted to enter the driving road in addition to the existing vehicle warning sound. Further, the speaker 321 may provide a voice guidance informing that a predicted pedestrian P is predicted to enter the driving road. While the speaker 321 may be provided in the door 14 of the vehicle 1, the position of the capturer 310 is not limited thereto.

On the top panel of the dashboard 210, a display 322 may be installed. The display 322 may be configured to output various information in the form of images to the driver or the passenger of the vehicle 1. For example, the display 322 may be configured to output various information, such as maps, weather, news, various moving or still images, information regarding the status or operation of the vehicle 1, e.g., information regarding the air conditioner, etc.

Furthermore, the display 322 may warn that a pedestrian is predicted to enter the driving road. For example, when the pedestrian is predicted to enter the driving road on which the vehicle 1 drives, the display 322 may display a warning indicating that a pedestrian is predicted to enter the driving road.

The display 322 may be implemented with a commonly-used navigation device.

The display 322 may be installed inside a housing integrally formed with the dashboard 210 such that the display 322 may be exposed. Alternatively, the display 322 may be installed in the middle or the lower part of the center fascia 211, or may be installed on the inside of a windshield (not shown) or on the top of the dashboard 210 by a separate supporter (not shown). The vehicle display 322 may be installed at any position that may be considered by the designer.

A head up display (HUD) 323 may be installed on the upper surface of the dashboard 210. The HUD 323 may display on the front window 19a the warning indicating that a pedestrian is predicted to enter the driving road on which the vehicle 1 drives.

In addition, the HUD 323 may display the predicted behavior of the pedestrian. The HUD 323 may display the predicted posture and position of the pedestrian after a certain point in time from the current point of view based on the predicted behavior of the pedestrian.

Behind the dashboard 210, various types of devices, such as a processor, a communication module, a global positioning system (GPS) module, a storage, etc., may be installed. The processor installed in the vehicle 1 may be configured to operate various electronic devices installed in the vehicle 1, and may operate as the controller 300. The aforementioned devices may be implemented using various parts, such as semiconductor chips, switches, integrated circuits, resistors, volatile or nonvolatile memories, PCBs, and/or the like.

The center fascia 211 may be installed in the middle of the dashboard 210, and may include inputters 330a to 330c configured to receive various instructions related to the vehicle 1 from user input or selection. The inputters 330a to 330c may be implemented with mechanical buttons, knobs, a touch pad, a touch screen, a stick-type manipulation device, a trackball, or the like. The driver may execute many different operations of the vehicle 1 by manipulating the various inputters 330a to 330c.

The gear box 215 is disposed below the center fascia 211 between the driver's seat 201 and the passenger seat 202. In the gear box 215, a transmission 216, a container box 217, various inputters 330d and 330e, etc., are included. The inputters 330d and 330e may be implemented with mechanical buttons, knobs, a touch pad, a touch screen, a stick-type manipulation device, a trackball, or the like. The container box 217 and the inputters 330d and 330e may be omitted in some exemplary embodiments.

The driver may operate the inputter 330 to activate or deactivate the function provided by the disclosure.

The steering wheel 220 and the instrument panel 230 are disposed on the dashboard 210 in front of the driver's seat 201.

The steering wheel 220 may be rotated in a particular direction by the manipulation of the driver, and accordingly, the front or back wheels of the vehicle 1 are rotated, thereby steering the vehicle 1. The steering wheel 220 may include a spoke 221 connected to a rotation shaft and a wheel for gripping 222 combined with the spoke 221. On the spoke 221, an inputter may be provided configured to receive various instructions as input from the user, and the inputter may be implemented with mechanical buttons, knobs, a touch pad, a touch screen, a stick-type manipulation device, a trackball, or the like. The wheel for gripping 222 may have a radial form to be conveniently manipulated by the driver, but is not limited thereto. Further, a turn signal lamps inputter 330f may be provided behind the steering wheel 220. The driver may input a signal for changing the driving direction or the lane through the turn signal lamps inputter 330f during driving of the vehicle 1.

The instrument panel 230 may provide the driver with various information related to the vehicle 1 such as the speed of the vehicle 1, engine revolutions per minute (rpm), fuel remaining, temperature of engine oil, flickering of turn signals, distance traveled by the vehicle, etc. The instrument panel 230 may be implemented with lights, indicators, or the like, and it may be implemented with a display panel as well, in some exemplary embodiments. When the instrument panel 230 is implemented with the display panel, in addition to the aforementioned information, the instrument panel 230 may provide other various information such as the gas mileage, whether various functions of the vehicle 1 are performed, or the like to the driver through the display 322.

The object described in the embodiment of the present disclosure may include the driver and the pedestrian. Hereinafter, the case where the object is a ‘pedestrian’ will be described as an example. In addition, a behavior to be changed after a certain point in the current behavior of the object described in the embodiment of the present disclosure is defined as ‘next behavior.’ In addition, the following predicted behavior of the object described in the embodiment of the present disclosure is defined as ‘predictive behavior.’ In addition, the pedestrian that is the target of behavioral prediction in the embodiment of the present disclosure is defined as a ‘predicted pedestrian.’

The embodiment of the present disclosure is not limited to the certain point in time, and may be set by the designer or set and changed by the user.

Referring to FIG. 3, the vehicle 1 according to the embodiment may include the capturer 310, the inputter 330, an output 32, the display 322, and the HUD 323 and may further include the controller 300 for controlling each configuration of the vehicle 1, and a storage 390 for storing data related to the control of the vehicle 1

The controller 300 may include at least one memory that stores a program for performing the operations described below, and at least one processor that executes the stored program.

The controller 300 may include a situation recognizer 340, a behavior predictor 350, a learning machine 360, a driving information obtaining device 370, and a vehicle controller 380.

The situation recognizer 340, the behavior predictor 350, the learning machine 360, the driving information obtaining device 370 and the vehicle controller 380 may share a memory or processor with other components or may use a separate memory or processor.

The situation recognizer 340 may recognize the surrounding situation of the vehicle 1 based on the images of the objects around the vehicle captured by the capturer 310. In particular, the situation recognizer 340 may recognize the type of road (a highway or a general national road) on which the vehicle 1 is driving, and may recognize at least one of the presence or absence of a traffic light on the vehicle driving path and the presence or absence of a crosswalk on the vehicle driving path.

In addition, the situation recognizer 340 may recognize the surrounding situation of the vehicle 1 based on a global positioning system (GPS) signal. In particular, the situation recognizer 340 may recognize the type of the road on which the vehicle 1 is driving based on the GPS signal, and may recognize at least one of the presence of a traffic light on the vehicle driving path and the presence or absence of a crosswalk on the vehicle driving path.

Although it has been described that the surrounding situation of the vehicle 1 according to the embodiment of the disclosure may include the type of the road on which the vehicle 1 is driving, the presence or absence of a traffic light on the vehicle driving route, and the presence or absence of a crosswalk on the vehicle driving route, it may also include any situation information which can determine that a pedestrian may appear.

The situation recognizer 340 may determine whether or not a pedestrian may appear based on the recognized surrounding situation of the vehicle 1.

The situation recognizer 340 may recognize the surrounding situation of the vehicle through the capturer 310 or the GPS signal. The situation recognizer 340 may determine whether or not a pedestrian may appear based on the recognized surrounding situation of the vehicle 1.

In particular, the situation recognizer 340 may determine that a pedestrian may appear when the road on which the vehicle 1 drives is a general national road on which a pedestrian may appear, a traffic light exists on the vehicle driving path, or a crosswalk exists on the vehicle driving path.

The situation recognizer 340 may transmit a trigger signal to the behavior predictor 350 indicating the start of behavior prediction of the behavior predictor 350 when it is determined that a pedestrian may appear based on the surrounding situation of the vehicle 1.

On the contrary, the situation recognizer 340 may determine that a pedestrian cannot appear when the road on which the vehicle 1 drives is a highway on which a pedestrian cannot appear, a traffic light does not exist on the vehicle driving path, or a crosswalk does not exist on the vehicle driving path.

The situation recognizer 340 may continuously perform an operation of recognizing the surrounding situation of the vehicle when it is determined that a pedestrian cannot appear based on the surrounding situation of the vehicle.

When the situation recognizer 340 determines that a pedestrian may appear, it may determine to start the process of predicting the behavior of the pedestrian. Accordingly, the situation recognizer 340 may transmit the trigger signal indicating the start of operation of the behavior predictor 350.

The trigger signal may correspond to a signal that the behavior predictor 350 indicates to start the behavioral prediction. In particular, when the situation recognizer 340 determines that a pedestrian may appear, the behavior predictor 350 may generate the trigger signal for indicating the behavior predictor 350 to start the behavior prediction, and may transmit the trigger signal to the behavior predictor 350.

The behavior predictor 350 may start the behavior prediction of the object upon receiving the trigger signal. The behavior predictor 350 may recognize the predicted object that is the object of behavior prediction among the objects captured through the capturer 310 and obtain the image of the predicted object. The next behavior of the predicted object may be predicted based on the recognized image of the predicted object.

The image processor 351 of the behavior predictor 350 may obtain the joint image information corresponding to the movement of the joints of the object based on the image of the object captured in real time through the capturer 310.

A behavior prediction classifier 352 of the behavior predictor 350 may predict the next behavior of the object based on the joint image information and obtain prediction behavior information indicating the prediction behavior.

The behavior prediction classifier 352 may obtain learning information stored in the storage 390, predict the next behavior of the object based on the change of each joint feature of the object and the learning information, and obtain the prediction behavior information indicating the prediction behavior.

The learning machine 360 may learn the next behavior of the object according to the change of each joint characteristic of the object using the machine learning algorithm. That is, the learning machine 360 may generate the learning information that can predict the next behavior of the object corresponding to the change of each joint feature of the object by learning the next behavior of the object according to the change of each joint feature.

The learning machine 360 may continuously generate the learning information by learning the next behavior of the object according to the change of the joint features of the object while the vehicle 1 is driving. The learning information generated by the learning machine 360 may be stored in the storage 390 and the learning information stored in the storage 390 may include the learning information obtained from the previous driving of the vehicle 1.

The driving information obtaining device 370 may collect the vehicle driving information of the vehicle 1 while the vehicle 1 is driving. The vehicle driving information may include the driving speed of the vehicle 1, whether it is accelerated or decelerated, and the like.

The behavior predictor 350 may determine the need for vehicle control based on the predicted pedestrian behavior change and the vehicle driving information when the object is a pedestrian.

The behavior predictor 350 may determine that there is need for vehicle control when predicting the possibility of collision between the vehicle 1 and a pedestrian. Also, the behavior predictor 350 may determine that there is no need for vehicle control when predicting that there is no possibility of collision between the vehicle 1 and a pedestrian, and when the pedestrian is predicted not to enter the driving road on which the vehicle 1 drives. When there is need for vehicle control, the behavior predictor 350 may transmit a vehicle control signal to the vehicle controller 380.

The vehicle controller 380 may control the vehicle 1 so as to avoid collision with a pedestrian based on the vehicle control signal when the object is a pedestrian. In particular, the vehicle controller 380 may control a brake so that the vehicle 1 stops or decelerates based on a braking control signal of the vehicle control signal. In addition, the vehicle control signal may include a steering control signal for controlling the vehicle steering apparatus so that the vehicle 1 can change lanes so as to avoid collision with the predicted pedestrian P. Thereby, the vehicle 1 may perform a stop, deceleration or lane change to avoid collision with the pedestrian. In addition, the vehicle controller 380 may control the vehicle 1 to provide a warning that a pedestrian is predicted to enter the driving road.

In addition, the behavior predictor 350 may output the vehicle control signal to enable the vehicle controller 380 to activate the brake system when the object is the driver and the driver's behavior is predicted to change to a brake pedal operation.

The storage 390 may store various data related to the control of the vehicle 1. In particular, the storage 390 may store the vehicle driving information related to the obtained driving speed, acceleration, deceleration, driving distance, and driving time by the driving information obtaining device 370 of the vehicle 1 according to the embodiment, and may store images of the object captured by the capture 310.

The storage 390 may also store the learning information used in predicting the behavior of the object generated by the learning machine 360.

The storage 390 may also store data related to the formulas and control algorithms for controlling the vehicle 1 according to the embodiment and the controller 300 may transmit the control signal for controlling the vehicle 1 according to the formulas and the control algorithms.

The storage 390 may be implemented with at least one of a non-volatile memory device, such as cache, read only memory (ROM), programmable ROM (PROM), erasable programmable ROM (EPROM), electrically erasable programmable ROM (EEPROM), a volatile memory device, such as random access memory (RAM), or a storage medium, such as hard disk drive (HDD) or compact disk (CD-ROM), without being limited thereto. The storage 390 may be a memory implemented with a chip separate from a processor, which will be described later, in relation to the controller 300, or may be implemented integrally with the processor in a single chip.

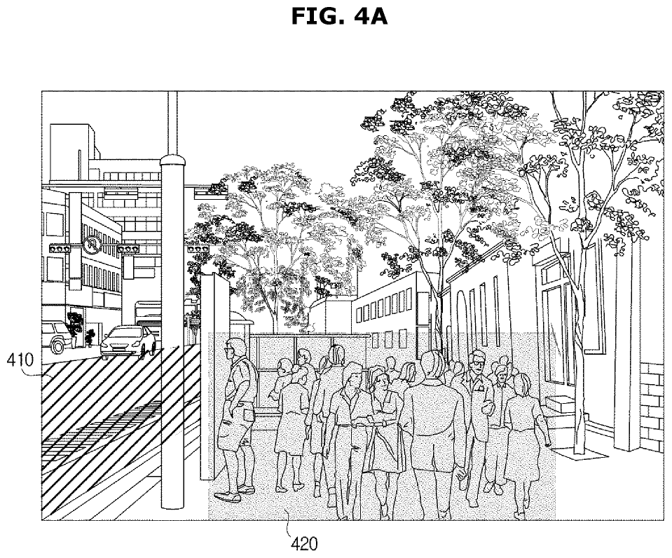

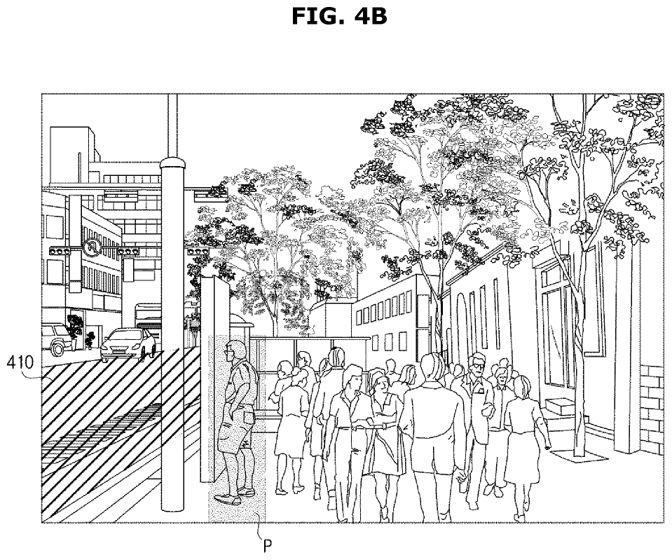

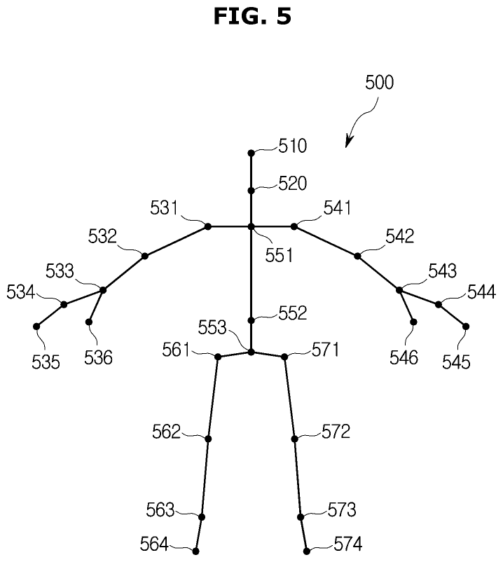

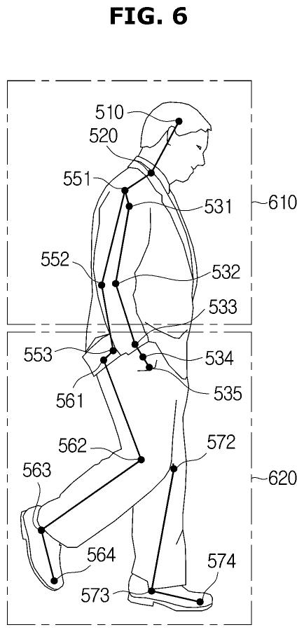

FIGS. 4A and 4B are conceptual diagrams illustrating a method for determining a pedestrian to be a target of behavior prediction when a plurality of pedestrians is recognized according to an embodiment, and FIGS. 5 and 6 are conceptual diagrams illustrating joint image information generated according to an embodiment.

The behavior predictor 350 may receive the trigger signal transmitted by the situation recognizer 340. The behavior predictor 350 may perform the operation of predicting the next behavior of the pedestrian based on the trigger signal received from the situation recognizer 340.

The behavior predictor 350 may recognize the predicted pedestrian through the capturer 310. The capturer 310 may capture an image around the vehicle 1 in real time while driving or stopping the vehicle 1. When the pedestrian is positioned around the driving road of the vehicle 1, the captured image of the pedestrian may be transmitted to the behavior predictor 350.

The behavior predictor 350 may recognize the predicted pedestrian around the driving road based on the image captured by the capturer 310.

When there is a plurality of pedestrians around the driving road of the vehicle 1, the behavior predictor 350 may recognize the pedestrian positioned at the position closest to the driving road of the vehicle 1 as the predicted pedestrian.

Referring to FIG. 4A, a plurality of pedestrians 420 may be positioned around a driving road 410 on which the vehicle 1 drives.

The capturer 310 may capture the image around the vehicle 1 and transmit the captured image to the behavior predictor 350.

Referring to FIG. 4B, the behavior predictor 350 may recognize the pedestrian positioned at the position closest to the driving road 410 among the plurality of pedestrians 420 displayed in the captured image as the predicted pedestrian P.

In particular, when the plurality of pedestrians 420 are captured, the behavior predictor 350 may recognize the pedestrian positioned closest to the driving road 410 as the predicted pedestrian P to be a target of the behavioral prediction.

This is because the possibility that the pedestrian positioned at the closest position to the driving road 410 enters the driving road 410 and collides with the vehicle 1 may be the highest.

Accordingly, when there is another pedestrian moved to be closer to the driving road 410 in addition to the pedestrian positioned at the position closest to the driving road 410, the behavior predictor 350 may determine that the another pedestrian as the predicted pedestrian to be the target of the behavioral prediction.

The behavior predictor 350 may obtain the image for the predicted pedestrian P through the capturer 310. In particular, when the predicted pedestrian P is recognized, the capturer 310 may capture the image of the predicted pedestrian P in real time and transmit the image of the predicted pedestrian P to the behavior predictor 350.

The behavior predictor 350 may receive the image of the predicted pedestrian P captured by the capturer 310.

In addition, the behavior predictor 350 may predict the next behavior of the predicted pedestrian P based on the image of the predicted pedestrian P received from the capturer 310. The predictive behavior may indicate the predicted next behavior of the predicted pedestrian P at the certain point in time from the current point of view of the predicted pedestrian P.

The embodiment of the present disclosure is not limited to the certain point in time, and may be set by the designer or set and changed by the user.

The behavior predictor 350 may obtain joint image information based on the image of the predicted pedestrian P. In particular, the behavior predictor 350 may obtain the joint image information corresponding to the motion of the joints of the predicted pedestrian P based on the image of the predicted pedestrian P received from the capturer 310.

The image processor 351 of the behavior predictor 350 may obtain the joint image information corresponding to the motion of the joints of the predicted pedestrian P based on the image of the predicted pedestrian P captured in real time through the capturer 310.

The image processor 351 may calculate the position of each joint of the predicted pedestrian P based on the image of the predicted pedestrian P. The image processor 351 may obtain the joint image information indicating the positions of the joints of the body part, the arm part, and the leg part based on the face or head of the predicted pedestrian P according to the rectangle fitting algorithm.

For example, the joint image information may be a skeleton model corresponding to the motion of the joints of the predicted pedestrian P.

In particular, in the joint image information, the position of the central point of a head part may be determined as a feature point, and the remaining body part, arm part, and leg part may be determined as a feature point at the joint positions where the respective arthropods are connected or the end positions of the respective arthropods.

Referring to FIG. 5, joint image information 500 may include a total of 25 feature points and may be determined to be the position of a head center 510, a neck 520, a right shoulder joint 531, a right elbow joint 532, a right wrist joint 533, a right hand joint 534, a right hand end 535, a right thumb joint 536, a left shoulder joint 541, a left elbow joint 542, a left wrist joint 543, a left hand joint 544, a left hand end 545, a left thumb joint 546, a shoulder spinal joint 551, a spinal joint 552, a pelvic spinal joint 553, a right pelvic joint 561, a right knee joint 562, a right ankle joint 563, a right foot end 564, a left pelvic joint 571, a left knee joint 572, a left ankle joint 573, and a left foot end 574.

Meanwhile, the number of feature points of the joint image information according to the embodiment is not limited to the specific embodiment, and more feature points may be used by using an inverse kinematics algorithm or the like.

In addition, the image of the predicted pedestrian P may contain only a body part image of the predicted pedestrian P, not the whole body image of the predicted pedestrian P according to the position and behavior of the predicted pedestrian P.

For example, the image of the predicted pedestrian P may contain only a side image, not the whole body image of the predicted pedestrian P according to the position and behavior of the predicted pedestrian P.

The behavior predictor 350 may obtain the joint image information based on the side image when the image of the predicted pedestrian P includes only the side image of the predicted pedestrian P.

Referring to FIG. 6, the joint image information obtained by the behavior predictor 350 based on the side image may include only the feature points of some of the 25 feature points.

For example, the joint image information obtained based on the side image may include the head center 510, the neck 520, the right shoulder joint 531, the right elbow joint 532, the right wrist joint 533, the right hand joint 534, the right hand end 535, the right thumb joint 536, the shoulder spinal joint 551, the spinal joint 552, the pelvic spinal joint 553, the right pelvic joint 561, the right knee joint 562, the right ankle joint 563, the right foot end 564, the left pelvic joint 571, the left knee joint 572, the left ankle joint 573, and the left foot end 574.

Thus, when the image of the predicted pedestrian P includes only the body part image of the predicted pedestrian P, the behavior predictor 350 may obtain the joint image information based only on the image of the body part.

However, when the joint image information includes only upper body image information 610 for the upper body of the predicted pedestrian P, the behavior predictor 350 may suspend the behavioral prediction determination on the predicted pedestrian P until obtaining lower body image information 620 for a lower body of the predicted pedestrian P.

The lower body of the pedestrian corresponds to the part of the body which is most involved in motion such as stopping, walking and running. The upper body of the pedestrian may operate in response to the lower body motion of the pedestrian. Therefore, the joint image information for the behavior prediction of the predicted pedestrian P must include the lower body image information 620 for the lower body of the predicted pedestrian P.

In addition, the lower body image information 620 with respect to the lower body may be preferentially considered in comparison with the upper body image information 610 with respect to the upper body in the behavior prediction of the predicted pedestrian P.

The behavior predictor 350 may obtain current behavior information for the predicted pedestrian P based on the joint image information.

The behavior predictor 350 may calculate the joint characteristics of the predicted pedestrian P based on the feature points on the obtained joint image information and obtain the current behavior information indicating the current behavior of the predicted pedestrian P based on the joint characteristics of the predicted pedestrian P.

In particular, the behavior predictor 350 may obtain the current behavior information indicating that the current behavior of the predicted pedestrian P is one of stopping, walking and running based on the feature points on the obtained joint image information.

For example, the behavior predictor 350 may analyze the feature points on the obtained joint image information and obtain the current behavior information indicating that the current behavior of the predicted pedestrian P is stopping when it is determined that the angles of the right knee joint 562 and the left knee joint 572 are greater than or equal to a first threshold angle and the right knee joint 562 and the left knee joint 572 are determined not to be bent.

The behavior predictor 350 may analyze the feature points on the obtained joint image information and obtain the current behavior information indicating that the current behavior of the predicted pedestrian P is walking when it is determined that the angles of the right knee joint 562 and the left knee joint 572 are less than or equal to the first threshold angle and greater than or equal to a second first threshold angle and the right knee joint 562 and the left knee joint 572 are determined to be bent.

In addition, the behavior predictor 350 may analyze the feature points on the obtained joint image information and obtain the current behavior information indicating that the current behavior of the predicted pedestrian P is running when it is determined that the angles of the right knee joint 562 and the left knee joint 572 are less than or equal to the second first threshold angle and the right knee joint 562 and the left knee joint 572 are determined to be bent.

In the embodiment of the disclosure, the first threshold angle represents the maximum angle of the knee joint angle that may be present when a typical pedestrian is walking, and the second threshold angle represents the maximum angle of the knee joint angle that may be present when the typical pedestrian is running.

The behavior predictor 350 may obtain the current behavior information indicating the current behavior of the predicted pedestrian P by considering the angles of the elbow joints 532 and 542 and the angles of the ankle joints 563 and 573 and the positions of the pelvic joints 561 and 571 in addition to the angles of the knee joints 562 and 572.

In the embodiment of the disclosure, it is described that the current operation information indicating the current behavior of the predicted pedestrian P is obtained in consideration of the joint characteristics such as the angle of the knee joints 562 and 572, the angle of the elbow joints 532 and 542, the angle of the ankle joints 563 and 573, and the position of the joints of the pelvis joints 561 and 571. However, the present disclosure is not limited to the characteristics of the joints, and may include, without limitation, characteristics of the joints that may be present in the motions such as stopping, walking and running of the typical pedestrian.

Thus, the behavior predictor 350 may obtain the current behavior information indicating the current behavior of the predicted pedestrian P by considering the characteristics of the joints that may be present in the motions such as stopping, walking and running of the pedestrian.

The behavior predictor 350 may obtain predictive behavior information of the predicted pedestrian P based on the joint image information.

The behavior prediction classifier 352 of the behavior predictor 350 may predict the next behavior of the pedestrian based on the joint image information and obtain the predictive behavior information indicating the predictive behavior.

The behavior predictor 350 may calculate the change of each joint characteristic corresponding to each feature point based on the feature points on the obtained joint image information and obtain the predictive behavior information indicating the predictive behavior of the predicted pedestrian P based on the change of each joint characteristic.

The behavior prediction classifier 352 of the behavior predictor 350 may receive the change in each joint characteristic of the calculated predicted pedestrian P and obtain the predictive behavior information indicating that the predictive behavior of the predicted pedestrian P is one of stopping, walking and running based on the learning information received from the storage 390.

The learning information used for predicting the behavior of the predicted pedestrian P may be generated by the learning machine 360 and stored in the storage 390.

In particular, the learning machine 360 may learn the next behavior of the pedestrian in a previous driving according to the change of each joint characteristic of the pedestrian in the previous driving using the machine learning algorithm. That is, the learning machine 360 may generate the learning information that can predict the next behavior of the pedestrian corresponding to the change of each joint characteristic of the pedestrian by learning the next behavior of the pedestrian according to the change of each joint characteristic. Here, the next behavior of the pedestrian may correspond to one of stopping, walking and running.

The learning machine 360 may obtain the change of the respective joint characteristics and the next behaviors of the pedestrian according to the behavior change of the pedestrian through the joint image information.

The learning machine 360 may learn the next behavior of the pedestrian according to the change of each joint characteristic of the pedestrian using the machine learning algorithm.

For example, the learning machine 360 may analyze the feature points on the obtained joint image information and obtain the learning information indicating that the next behavior of the pedestrian corresponds to walking when it is determined that the angle of the right knee joint 562 or the left knee joint 572 changes from the first threshold angle to the first threshold angle and the next behavior of the pedestrian corresponds to walking.

In addition, the learning machine 360 may analyze the feature points on the obtained joint image information and obtain the learning information indicating that the next behavior of the pedestrian corresponds to running when it is determined that the angle of the right knee joint 562 or the left knee joint 572 changes from the first threshold angle to the first threshold angle and the next behavior of the pedestrian corresponds to running.

In the embodiment of the disclosure, the first threshold angle represents the maximum angle of the knee joint angle that may be present when a typical pedestrian is walking, and the second threshold angle represents the maximum angle of the knee joint angle that may be present when the typical pedestrian is running.

The learning machine 360 may obtain the learning information indicating the next behavior of the pedestrian according to the change of the joint characteristics of the pedestrian by considering the change of the angles of the elbow joints 532 and 542, the change of the angles of the ankle joints 563 and 573 and the change of the positions of the pelvic joints 561 and 571 in addition to the change of the angles of the knee joints 562 and 572.

In the embodiment of the disclosure, it is described that the learning information indicating the next behavior of the pedestrian according to the change of the joint characteristics of the pedestrian is obtained in consideration of the change of the joint characteristics such as the change of the angle of the knee joints 562 and 572, the change of the angle of the elbow joints 532 and 542, the angle of the ankle joints 563 and 573, and the change of the position of the joints of the pelvis joints 561 and 571. However, the present disclosure is not limited to the change of the joint characteristics, and may include, without limitation, the change of the joint characteristics that may be present in the motions such as stopping, walking and running of the typical pedestrian.

Accordingly, the learning machine 360 may generate the learning information indicating the next behavior of the pedestrian in the previous driving according to the change of each joint characteristic of the pedestrian in the previous driving.

When the next behavior of the pedestrian is stopping, the learning machine 360 may match the learning information indicating that the change of each joint characteristic at the time of changing to stopping and the next behavior of the pedestrian corresponds to stopping. When the next behavior of the pedestrian is walking, the learning machine 360 may match the learning information indicating that the change of each joint characteristic at the time of changing to walking and the next behavior of the pedestrian corresponds to walking. When the next behavior of the pedestrian is running, the learning machine 360 may match the learning information indicating that the change of each joint characteristic at the time of changing to running and the next behavior of the pedestrian corresponds to running.

The learning machine 360 may store in the storage 390 the learning information indicating the next behavior of the pedestrian in the previous driving according to the change of each joint characteristic of the pedestrian in the previous driving.

The behavior prediction classifier 352 may obtain the learning information stored in the storage 390 and obtain the predictive behavior information indicating the predictive behavior of the predicted pedestrian P based on the change of each joint characteristic of the predicted pedestrian P and the learning information.

That is, the behavior prediction classifier 352 may detect that the following behavior corresponds to the change of each joint characteristic of the predicted pedestrian P when the next behavior of the predicted pedestrian P corresponds to one of stopping, walking and running based on the learning information, and may predict that the next behavior of the predicted pedestrian P corresponds to one of stopping, walking and running.

The behavior predictor 350 may obtain the predictive behavior information indicating the predictive behavior of the predicted pedestrian P based on the predicted next behavior of the pedestrian of the behavior prediction classifier 352.

The behavior predictor 350 may obtain the behavior change prediction information by comparing the current behavior information and the predictive behavior information.

The behavior predictor 350 may obtain the current behavior information indicating the current behavior of the predicted pedestrian P and the predictive behavior information indicating the predictive behavior of the predicted pedestrian P based on the joint image information.

The behavior predictor 350 may obtain the behavior change prediction information indicating the change of the behavior of the predicted pedestrian P that changes from the current behavior to the predictive behavior by comparing the current behavior information and the predicted behavior information.

In particular, the behavior predictor 350 may obtain the behavior change prediction information including information that predicts whether the current behavior of the predicted pedestrian P corresponding to one of stopping, walking and running represented by the current behavior information is changed into the predictive behavior of the predicted pedestrian P corresponding to one of stopping, walking and running represented by the predictive behavior information.

The behavior change prediction information may include information about the current behavior of the predicted pedestrian P and the predictive behavior of the predicted pedestrian P.

The behavior predictor 350 can determine the necessity of controlling the vehicle 1 based on the behavior change prediction information and the vehicle driving information.

The behavior predictor 350 may predict whether the predicted pedestrian P will enter the driving road on which the vehicle 1 drives based on the behavior change prediction information.

In particular, the behavior predictor 350 may identify whether the current operation of the predicted pedestrian P is one of stopping, walking and running based on the behavior change prediction information, and whether the predictive behavior of the predicted pedestrian P is one of stopping, walking and running.

If the current operation of the predicted pedestrian P is one of stopping, walking and running, and the predictive behavior of the predicted pedestrian P is one of walking and running, the behavior predictor 350 may predict that the predicted pedestrian P will enter the driving road on which the vehicle 1 drives.

If the current operation of the predicted pedestrian P is one of stopping, walking and running, and the predictive behavior of the predicted pedestrian P is stopping, the behavior predictor 350 may predict that the predicted pedestrian P will not enter the driving road on which the vehicle 1 drives.

In addition, the behavior predictor 350 may obtain the driving information of the vehicle 1 from the driving information obtaining device 370. The behavior predictor 350 may predict the possibility of collision between the vehicle 1 and the predicted pedestrian P based on the driving information when the predicted pedestrian P is predicted to enter the driving road on which the vehicle 1 drives.

The vehicle driving information may include the driving speed of the vehicle 1, whether it is accelerated or decelerated, and the like.

When it is determined that the vehicle 1 will proceed to the point where the predicted pedestrian P is positioned at the time when the predicted pedestrian P is predicted to enter the driving road based on the driving information, the behavior predictor 350 may predict that there is a possibility of collision between the vehicle 1 and the predicted pedestrian P.

For example, when it is determined that the vehicle 1 is driving at a high speed based on the driving information and drives to the point where the predicted pedestrian P is positioned, the behavior predictor 350 may predict that there is a possibility of collision between the vehicle 1 and the predicted pedestrian P.

In addition, when it is determined that the vehicle 1 will not proceed to the point where the predicted pedestrian P is positioned at the time when the predicted pedestrian P is predicted to enter the driving road based on the driving information, the behavior predictor 350 may predict that there is no possibility of collision between the vehicle 1 and the predicted pedestrian P.

For example, when it is determined that the vehicle 1 is stopped or driving at a low speed based on the driving information and does not drive to the point where the predicted pedestrian P is positioned, the behavior predictor 350 may predict that there is no possibility of collision between the vehicle 1 and the predicted pedestrian P.

The behavior predictor 350 may determine that there is need for vehicle control when it is predicted that there is a possibility of collision between the vehicle 1 and the predicted pedestrian P. In addition, the behavior predictor 350 may determine that there is no need for vehicle control when it is predicted that there is no possibility of collision between the vehicle 1 and the predicted pedestrian P and that the predicted pedestrian P predicts that the vehicle 1 will not enter the driving road on which the vehicle 1 drives.

When there is no need for the vehicle control, the behavior predictor 350 may terminate the procedure without controlling the vehicle.

When there is need for the vehicle control, the behavior predictor 350 may transmit the vehicle control signal.

The behavior predictor 350 may generate the vehicle control signal for controlling the vehicle 1 when the possibility of collision between the vehicle 1 and the predicted pedestrian P is predicted and transmit the vehicle control signal to the vehicle controller 380.

The vehicle control signal may include a braking control signal for controlling the brake so that the vehicle 1 can stop or decelerate. In addition, the vehicle control signal may include a steering control signal for controlling the vehicle steering system so that the vehicle 1 can change lanes to avoid collision with the predicted pedestrian P. The vehicle control signal may also include a warning control signal for controlling the speaker 321, the display 322 and the HUD 323 to warn the driver of the vehicle 1 that the predicted pedestrian P is predicted to enter the driving road.

The behavior predictor 350 may transmit the vehicle control signal to the vehicle controller 380 to control the vehicle 1. Thereby, the vehicle 1 may stop or decelerate to avoid collision with the predicted pedestrian P, and may warn the driver in the vehicle 1 that the predicted pedestrian P entered the driving road.

The behavior predictor 350 may also transmit the signal to the vehicle controller 380 indicating that there is need for vehicle control without transmitting the vehicle control signal. The vehicle controller 380 may determine that there is need for vehicle control based on the transmitted signal, and may perform vehicle control.

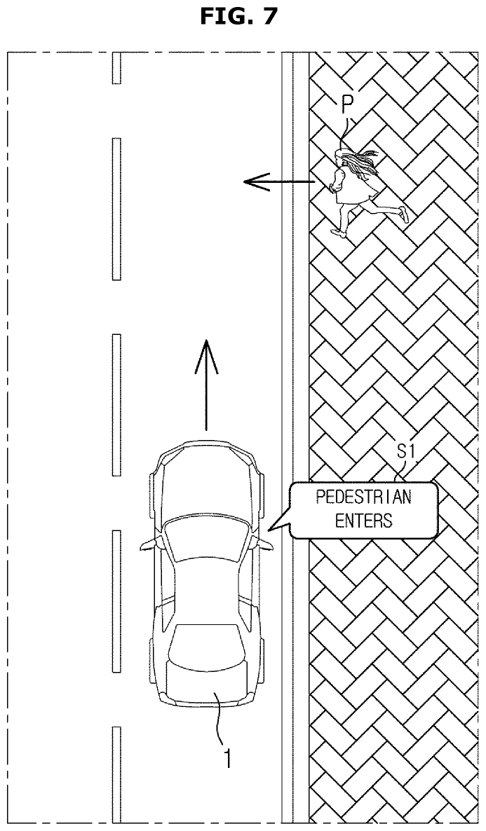

FIGS. 7 to 9 are diagrams illustrating an example of a warning that a vehicle can output when a pedestrian enters a driving road according to an embodiment.

The vehicle controller 380 may receive the vehicle control signal. The vehicle controller 380 may receive the vehicle control signal transmitted by the behavior predictor 350.

The vehicle control signal may include the braking control signal for controlling the brake so that the vehicle 1 can stop or decelerate. In addition, the vehicle control signal may include the steering control signal for controlling the vehicle steering system so that the vehicle 1 can change lanes to avoid collision with the predicted pedestrian P. The vehicle control signal may also include the warning control signal for controlling the speaker 321, the display 322 and the HUD 323 to warn the driver of the vehicle 1 that the predicted pedestrian P is predicted to enter the driving road.

The vehicle controller 380 may convert the received vehicle control signal into a component-specific compatible signal for each vehicle 1 so that the vehicle control signal is compatible with each component of the vehicle 1.

The vehicle controller 380 may control the vehicle 1 to avoid collision with the predicted pedestrian P.

The vehicle controller 380 may control the vehicle 1 to avoid collision with the predicted pedestrian P based on the vehicle control signal. In particular, the vehicle controller 380 may control the brake so that the vehicle 1 stops or decelerates based on the braking control signal of the vehicle control signal. Thereby, the vehicle 1 may stop or decelerate to avoid collision with the predicted pedestrian P.

Further, the vehicle controller 380 may control the vehicle steering apparatus so that the vehicle 1 changes the lane based on the steering control signal of the vehicle control signal. Thereby, the vehicle 1 may change the lane to avoid collision with the predicted pedestrian P.

Accordingly, the vehicle 1 may determine whether the predicted pedestrian P will enter the driving road in advance to prevent collision between the vehicle 1 and the predicted pedestrian P that may occur due to the driver's determination error or braking distance shortage.

The vehicle controller 380 may control the vehicle 1 to warn that the predicted pedestrian P is predicted to enter the driving road.

The vehicle controller 380 may receive the vehicle control signal transmitted by the behavior predictor 350 and control the speaker 321 to warn that the predicted pedestrian P is predicted to enter the driving road based on the warning control signal of the vehicle control signal. Thereby, the speaker 321 may warn that the predicted pedestrian P is predicted to enter the driving road.

For example, the speaker 321 may output a warning sound of a different pattern indicating that the predicted pedestrian P is predicted to enter the driving road in addition to the existing vehicle warning sound. Further, the speaker 321 may provide the voice guidance informing that the predicted pedestrian P is predicted to enter the driving road.

Referring to FIG. 7, when the predicted pedestrian P is predicted to enter the driving road on which the vehicle 1 drives, the speaker 321 may provide the voice guidance indicating that the predicted pedestrian P is predicted to enter the driving road as “pedestrian enters” (S1).

The vehicle controller 380 may also receive the vehicle control signal transmitted by the behavior predictor 350 and provide the display 322 to warn that the predicted pedestrian P is predicted to enter the driving road based on the warning control signal of the vehicle control signal. Thereby, the display 322 may warn that the predicted pedestrian P is predicted to enter the driving road.

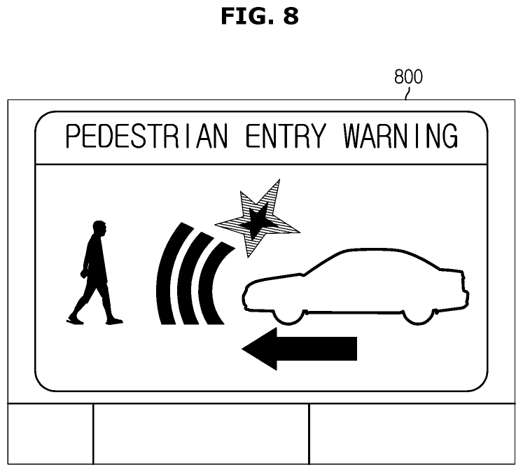

For example, the display 322 may display the warning indicating that the predicted pedestrian P is predicted to enter the driving road. Referring to FIG. 8, when the predicted pedestrian P is predicted to enter the driving road on which the vehicle 1 drives, the display 322 may display the warning indicating that the predicted pedestrian P is predicted to enter the driving road as “pedestrian entry warning.”

The vehicle controller 380 may also receive the vehicle control signal transmitted by the behavior predictor 350 and control the HUD 323 to warn that the predicted pedestrian P is predicted to enter the driving road based on the warning control signal of the vehicle control signal. Thereby, the HUD 323 may display on the front window 19a the warning indicating that the predicted pedestrian P is predicted to enter the driving road.

For example, when the predicted pedestrian P is predicted to enter the driving road on which the vehicle 1 drives, the HUD 323 may display on the front window 19a the warning indicating that the predicted pedestrian P is predicted to enter the driving road as “pedestrian entry warning.”

Also, the HUD 323 may display the predictive behavior of the predicted pedestrian P. The HUD 323 may display the predicted posture and position of the predicted pedestrian P after the certain point in time from the current point of view based on the predictive behavior of the predicted pedestrian P.

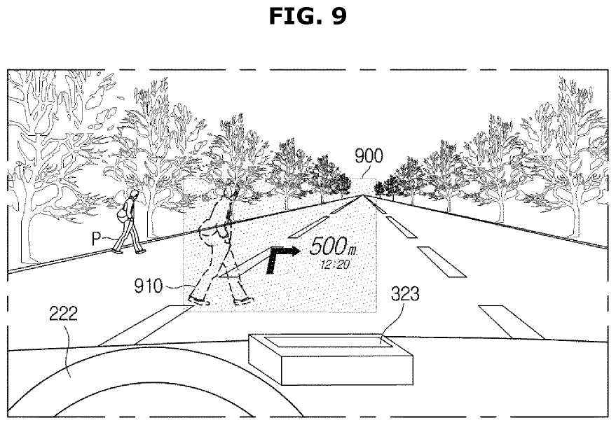

Referring to FIG. 9, the HUD 323 may display a silhouette 910 of the predicted pedestrian P after the certain point in time from the current point of view on a display area 900 of the front window 19a based on the predictive behavior of the predicted pedestrian P.

The silhouette 910 is the shape of the predicted pedestrian P after the certain point in time from the predicted current point of view based on the predictive behavior of the predicted pedestrian P. The silhouette 910 may reflect the predictive behavior of the predicted pedestrian P after the certain point in time.

In particular, the silhouette 910 may be displayed on the joint positions, the joint angles and directions of the joint of the predicted pedestrian P based on the predictive behavior and the joint image information, and based on this, the driver may more intuitively predict the predictive behavior of the predicted pedestrian P. That is, the driver may determine, based on the silhouette 901, the prediction behavior of the predicted pedestrian P, for example, whether or not the predicted pedestrian P is running or walking.

The HUD 323 may visually show how the predicted pedestrian P will enter the driving road by displaying the result of the predictive behavior of the predicted pedestrian P as the silhouette 910. Thereby the driver may intuitively recognize that the predicted pedestrian P will enter the driving road.

However, the vehicle 100 according to the embodiment may include a front windshield display (not shown) capable of outputting the image to the display area 900 of the front window 19a in addition to the HUD 323. The front windshield display may output the silhouette 910 of the predicted pedestrian P after the certain point in time from the current point of view based on the predictive behavior of the predicted pedestrian P.

The embodiment of the present disclosure is not limited to the certain point in time, and may be set by the designer or set and changed by the user.

The function of displaying the warning in the display area 900 of the front window 19a described in the embodiment of the disclosure may be implemented in such a form that the warning is displayed in the display area 900 of the front window 19a by a transparent display, or the like, and there is no limitation to the device which can display the warning on the front window 19a without discriminating the driver's view.

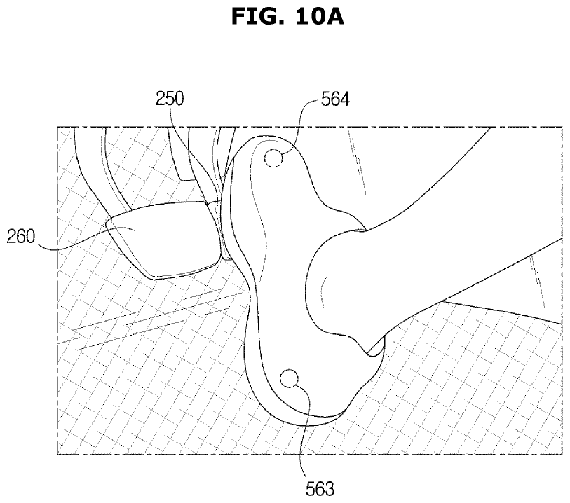

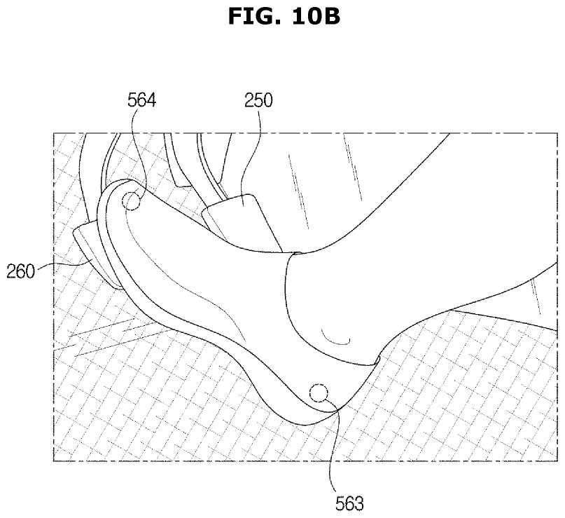

FIGS. 10A and 10B are diagrams illustrating a behavior of a driver when the driver operates the accelerator pedal 250 or the brake pedal 260 according to an embodiment.

The driver may use the accelerator pedal 250 and the brake pedal 260 when the vehicle 1 is driving. Since the brake pedal 260 is associated with the braking function, the possibility of collision and the degree of damage at the time of collision may vary depending on the reaction speed of the brake system.

The vehicle 1 may predict the behavior of the driver in addition to the function of the vehicle 1 that can predict the behavior of the predicted pedestrian P and prevent collision between the vehicle 1 and the predicted pedestrian P and when the driver is predicted to operate the brake pedal 260, the reaction speed of the brake system may be controlled so that the brake system can be activated immediately before the brake pedal 260 is depressed.

The behavior predictor 350 may obtain the image for the driver through the capturer 310.

The capturer 310 may capture the image of the driver in the vehicle 1 in real time and may transmit the image of the driver to the behavior predictor 350. Accordingly, the behavior predictor 350 may receive the image of the driver from the capturer 310.

The image of the driver described in the embodiment of the disclosure may include all the body parts of the driver. Hereinafter, the case where the image of the driver includes the foot of the driver will be described as an example.

The behavior predictor 350 may obtain the joint image information based on the image of the driver.

The image processor 351 of the behavior predictor 350 may obtain the joint image information that is image information including the position of the driver's joints based on the image of the driver received from the capturer 310.

For example, the joint image information may be the skeleton model corresponding to the motion of the joints of the predicted pedestrian P. In particular, the joint image information may be determined as the feature point on the right ankle joint 563 and the right foot end 564 of the driver based on the image of the driver.

The behavior predictor 350 may predict the possibility of operation of the brake pedal based on the joint image information.

The behavior predictor 350 may obtain the current behavior information of the driver based on the joint image information. The behavior predictor 350 may calculate the driver's foot direction and angle based on the feature points of the right ankle joint 563 and the right foot end 564 of the driver. Accordingly, the behavior predictor 350 may obtain the current behavior information indicating that the driver's current behavior corresponds to one of the accelerator pedal operation, the brake pedal operation, or the rest.

In addition, the behavior predictor 350 may obtain the predictive behavior information of the driver based on the joint image information.

The behavior prediction classifier 352 of the behavior predictor 350 may receive the change of characteristics of the right ankle joint 563 and the right foot end 564 of the driver and obtain the predictive behavior information indicating that the predictive behavior of the driver predicted based on the learning information received from the storage 390 is one of the accelerator pedal operation, the brake pedal operation, or the rest.

The learning information used for predicting the behavior of the driver may be generated by the learning machine 360 and stored in the storage 390.

In particular, the learning machine 360 may learn the driver's next behavior according to the change of each joint characteristic of the driver using the machine learning algorithm. That is, the learning machine 360 may learn the driver's next behavior according to the change of the characteristics of the right ankle joint 563 and the right foot end 564, and generate the learning information that can predict the driver's next behavior according to the change of the characteristics of the right ankle joint 563 and the right foot end 564 of the driver.

When the driver's next behavior is the accelerator pedal operation, the learning machine 360 may match the learning information indicating that the change of the characteristics of the right ankle joint 563 and the right foot end 564 when the driver's behavior changes to the accelerator pedal operation and the driver's next behavior corresponds to the accelerator pedal operation. When the driver's next behavior is the rest, the learning machine 360 may match the learning information indicating that the change of the characteristics of the right ankle joint 563 and the right foot end 564 when the driver's behavior changes to the rest and the driver's next behavior corresponds to the rest. When the driver's next behavior is the brake pedal operation, the learning machine 360 may match the learning information indicating that the change of the characteristics of the right ankle joint 563 and the right foot end 564 when the driver's behavior changes to the brake pedal operation and the driver's next behavior corresponds to the brake pedal operation.

The learning machine 360 may store the learning information indicating the driver's next behavior according to the change of each joint characteristic of the driver in the storage 390.

The behavior prediction classifier 352 of the behavior predictor 350 may detect that the change of each joint characteristic of the driver recognized based on the learning information corresponds to the change in the joint characteristics when the driver's next behavior is one of the accelerator pedal operation, the rest, or the brake pedal operation. Based on the driver's next behavior prediction of the behavior prediction classifier 352, the behavior predictor 350 may obtain the predictive behavior information indicating the predictive behavior of the predicted driver.

Referring to FIG. 10A, the behavior predictor 350 may determine that the direction of the driver's foot changes in the direction of the accelerator pedal 250 based on the change in the characteristics of the right ankle joint 563 and the right foot end 564 and that the angle of the driver's foot changes similarly to the angle of the foot when the accelerator pedal 250 is operated. The behavior predictor 350 may obtain the predictive behavior information indicating that the driver is to operate the accelerator pedal 250 based on the learning information.

Referring to FIG. 10B, the behavior predictor 350 may determine that the direction of the driver's foot changes in the direction of the brake pedal 260 based on the change in the characteristics of the right ankle joint 563 and the right foot end 564 and that the angle of the driver's foot changes similarly to the angle of the foot when the brake pedal 260 is operated. The behavior predictor 350 may obtain the predictive behavior information indicating that the driver is to operate the brake pedal 260 based on the learning information.

The behavior predictor 350 may obtain the behavior change prediction information by comparing the current behavior information and the predictive behavior information. The behavior predictor 350 may obtain the current behavior information indicating the driver's current behavior and the predictive behavior information indicating the driver's predictive behavior based on the joint image information.

The behavior predictor 350 may obtain the behavior change prediction information indicating the change in the behavior of the driver that changes from the current behavior to the predictive behavior by comparing the current behavior information and the predictive behavior information.

In particular, the behavior predictor 350 may obtain the behavior change prediction information including information that predicts whether the driver's current behavior corresponding to any one of the accelerator pedal operation, the rest and the brake pedal operation represented by the current behavior information changes the driver's predictive behavior corresponding to any one of the accelerator pedal operation, the rest and the brake pedal operation represented by the predictive behavior information.

The behavior change prediction information may include information about the driver's current behavior and the driver's predictive behavior.

The behavior predictor 350 may predict the possibility of operation of the driver's brake pedal based on the behavior change prediction information. In particular, the behavior predictor 350 may predict that the driver's behavior will change from the current behavior, which is the accelerator pedal operation or the rest, to the predictive behavior, which is the brake pedal operation, based on the behavior change prediction information.

The behavior predictor 350 may activate the brake system based on the brake pedal operability prediction.

The behavior predictor 350 may activate the brake system when predicting that the driver's behavior will change from the current behavior, which is the accelerator pedal operation or the rest, to the predictive behavior, which is the brake pedal operation, based on the behavior change prediction information.

In particular, the behavior predictor 350 may output the vehicle control signal to enable the vehicle controller 380 to activate the brake system when it is predicted that the driver's behavior will change to the brake pedal operation.

The brake system may be activated under the control of the vehicle controller 380, so that it can prepare the brake operation so that the vehicle 1 can brake immediately when the driver operates the brake pedal 260.

That is, the behavior predictor 350 may control the brake system so that the brake can be operated simultaneously with the operation of the brake pedal 260 of the driver.

Hereinafter, a vehicle control method according to the embodiment will be described. The above described vehicle 1 may be used in the vehicle control method according to the embodiment. Therefore, the contents of FIGS. 1 to 10 described above may be applied to the vehicle control method according to the embodiment without any particular reference.

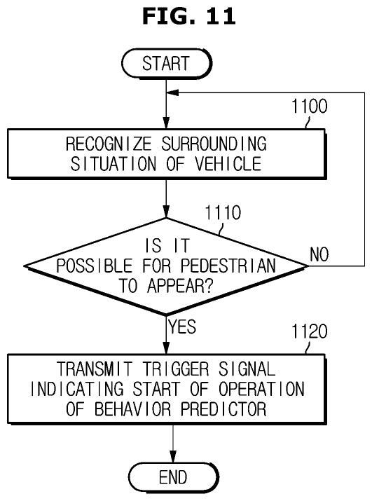

FIG. 11 is a flowchart illustrating a method for starting behavioral prediction in a vehicle control method according to an embodiment.

The situation recognizer 340 may recognize the surrounding situation of the vehicle 1 (1100).

The situation recognizer 340 may recognize the surrounding situation of the vehicle 1 based on the images of the objects around the vehicle captured by the capturer 310. In particular, the situation recognizer 340 may recognize the type of road (a highway or a general national road) on which the vehicle 1 is driving, and may recognize at least one of the presence or absence of a traffic light on the vehicle driving path and the presence or absence of a crosswalk on the vehicle driving path.

In addition, the situation recognizer 340 may recognize the surrounding situation of the vehicle 1 based on a global positioning system (GPS) signal. In particular, the situation recognizer 340 may recognize the type of the road on which the vehicle 1 is driving based on the GPS signal, and may recognize at least one of the presence of a traffic light on the vehicle driving path and the presence or absence of a crosswalk on the vehicle driving path.

Although it has been described that the surrounding situation of the vehicle 1 according to the embodiment of the disclosure may include the type of the road on which the vehicle 1 is driving, the presence or absence of a traffic light on the vehicle driving route, and the presence or absence of a crosswalk on the vehicle driving route, it may also include any situation information which can determine that a pedestrian may appear.

The situation recognizer 340 may determine whether or not a pedestrian is able to appear based on the recognized surrounding situation of the vehicle 1 (1110).

The situation recognizer 340 may determine that a pedestrian may appear when the road on which the vehicle 1 drives is a general national road on which a pedestrian may appear, a traffic light exists on the vehicle driving path, or a crosswalk exists on the vehicle driving path.

When the situation recognizer 340 determines that a pedestrian cannot appear based on the surrounding situation of the vehicle (NO in 1110), the situation recognizer 340 may continuously perform the operation of recognizing the surrounding situation of the vehicle 1.

When the situation recognizer 340 determines that a pedestrian may appear (YES in 1110), the situation recognizer 340 may determine to start the process of predicting the behavior of the pedestrian. Accordingly, the situation recognizer 340 may transmit the trigger signal indicating the start of operation of the behavior predictor 350 (1120).

The trigger signal may correspond to a signal that the behavior predictor 350 indicates to start the behavioral prediction. In particular, when the situation recognizer 340 determines that a pedestrian may appear, the behavior predictor 350 may generate the trigger signal for indicating the behavior predictor 350 to start the behavior prediction, and may transmit the trigger signal to the behavior predictor 350.

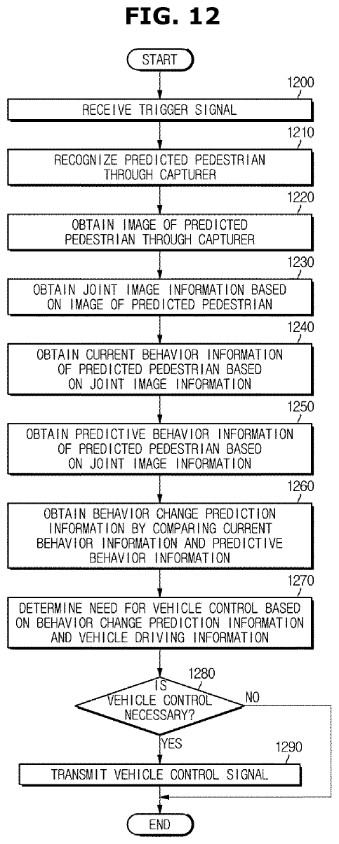

FIG. 12 is a flowchart illustrating a method for predicting the next behavior of a pedestrian in a vehicle control method according to an embodiment.

Referring to FIG. 12, the behavior predictor 350 may receive the trigger signal (1200).

In particular, the behavior predictor 350 may receive the trigger signal transmitted by the situation recognizer 340. The behavior predictor 350 may perform the operation of predicting the next behavior of the pedestrian based on the trigger signal received from the situation recognizer 340.

The behavior predictor 350 may recognize the predicted pedestrian through the capturer 310 (1210).

The behavior predictor 350 may recognize the predicted pedestrian around the driving road based on the image captured by the capturer 310.

When there is a plurality of pedestrians around the driving road of the vehicle 1, the behavior predictor 350 may recognize the pedestrian positioned at the position closest to the driving road of the vehicle 1 as the predicted pedestrian.

The behavior predictor 350 may obtain the image of the predicted pedestrian P through the capturer 310 (1220).

In particular, when the predicted pedestrian P is recognized, the capturer 310 may capture the image of the predicted pedestrian P in real time and transmit the image of the predicted pedestrian P to the behavior predictor 350.

The behavior predictor 350 may receive the image of the predicted pedestrian P captured by the capturer 310.

In addition, the behavior predictor 350 may predict the next behavior of the predicted pedestrian P based on the image of the predicted pedestrian P received from the capturer 310. The predictive behavior may indicate the predicted next behavior of the predicted pedestrian P at the certain point in time from the current point of view of the predicted pedestrian P.

The embodiment of the present disclosure is not limited to the certain point in time, and may be set by the designer or set and changed by the user.

The behavior predictor 350 may obtain joint image information based on the image of the predicted pedestrian P (1230).

In particular, the behavior predictor 350 may obtain the joint image information corresponding to the motion of the joints of the predicted pedestrian P based on the image of the predicted pedestrian P received from the capturer 310.

The image processor 351 of the behavior predictor 350 may obtain the joint image information corresponding to the motion of the joints of the predicted pedestrian P based on the image of the predicted pedestrian P captured in real time through the capturer 310.

The behavior predictor 350 may obtain current behavior information of the predicted pedestrian P based on the joint image information (1240).

The behavior predictor 350 may calculate the joint characteristics of the predicted pedestrian P based on the feature points on the obtained joint image information and obtain the current behavior information indicating the current behavior of the predicted pedestrian P based on the joint characteristics of the predicted pedestrian P.

In particular, the behavior predictor 350 may obtain the current behavior information indicating that the current behavior of the predicted pedestrian P is one of stopping, walking and running based on the feature points on the obtained joint image information.

The behavior predictor 350 may obtain the current behavior information indicating the current behavior of the predicted pedestrian P by considering the characteristics of the joints that may be present in the motions such as stopping, walking and running of the pedestrian.

The behavior predictor 350 may obtain predictive behavior information of the predicted pedestrian P based on the joint image information (1250).

The behavior prediction classifier 352 of the behavior predictor 350 may predict the next behavior of the pedestrian based on the joint image information and obtain the predictive behavior information indicating the predictive behavior.

The behavior predictor 350 may calculate the change of each joint characteristic corresponding to each feature point based on the feature points on the obtained joint image information and obtain the predictive behavior information indicating the predictive behavior of the predicted pedestrian P based on the change of each joint characteristic.

The behavior prediction classifier 352 of the behavior predictor 350 may receive the change in each joint characteristic of the calculated predicted pedestrian P and obtain the predictive behavior information indicating that the predictive behavior of the predicted pedestrian P is one of stopping, walking and running based on the learning information received from the storage 390.

The learning information used for predicting the behavior of the predicted pedestrian P may be generated by the learning machine 360 and stored in the storage 390.

In particular, the learning machine 360 may learn the next behavior of the pedestrian in a previous driving according to the change of each joint characteristic of the pedestrian in the previous driving using the machine learning algorithm. That is, the learning machine 360 may generate the learning information that can predict the next behavior of the pedestrian corresponding to the change of each joint characteristic of the pedestrian by learning the next behavior of the pedestrian according to the change of each joint characteristic. Here, the next behavior of the pedestrian may correspond to one of stopping, walking and running.

The learning machine 360 may obtain the change of the respective joint characteristics and the next behaviors of the pedestrian according to the behavior change of the pedestrian through the joint image information.

The learning machine 360 may learn the next behavior of the pedestrian according to the change of each joint characteristic of the pedestrian using the machine learning algorithm.

The learning machine 360 may generate the learning information indicating the next behavior of the pedestrian in the previous driving according to the change of each joint characteristic of the pedestrian in the previous driving.

When the next behavior of the pedestrian is stopping, the learning machine 360 may match the learning information indicating that the change of each joint characteristic at the time of changing to stopping and the next behavior of the pedestrian corresponds to stopping. When the next behavior of the pedestrian is walking, the learning machine 360 may match the learning information indicating that the change of each joint characteristic at the time of changing to walking and the next behavior of the pedestrian corresponds to walking. When the next behavior of the pedestrian is running, the learning machine 360 may match the learning information indicating that the change of each joint characteristic at the time of changing to running and the next behavior of the pedestrian corresponds to running.

The learning machine 360 may store in the storage 390 the learning information indicating the next behavior of the pedestrian in the previous driving according to the change of each joint characteristic of the pedestrian in the previous driving.

The behavior prediction classifier 352 may obtain the learning information stored in the storage 390 and obtain the predictive behavior information indicating the predictive behavior of the predicted pedestrian P based on the change of each joint characteristic of the predicted pedestrian P and the learning information.

That is, the behavior prediction classifier 352 may detect that the following behavior corresponds to the change of each joint characteristic of the predicted pedestrian P when the next behavior of the predicted pedestrian P corresponds to one of stopping, walking and running based on the learning information, and may predict that the next behavior of the predicted pedestrian P corresponds to one of stopping, walking and running.

The behavior predictor 350 may obtain the predictive behavior information indicating the predictive behavior of the predicted pedestrian P based on the predicted next behavior of the pedestrian of the behavior prediction classifier 352.

The behavior predictor 350 may obtain the behavior change prediction information by comparing the current behavior information and the predictive behavior information (1260).

The behavior predictor 350 may obtain the current behavior information indicating the current behavior of the predicted pedestrian P and the predictive behavior information indicating the predictive behavior of the predicted pedestrian P based on the joint image information.

The behavior predictor 350 may obtain the behavior change prediction information indicating the change of the behavior of the predicted pedestrian P that changes from the current behavior to the predictive behavior by comparing the current behavior information and the predicted behavior information.

In particular, the behavior predictor 350 may obtain the behavior change prediction information including information that predicts whether the current behavior of the predicted pedestrian P corresponding to one of stopping, walking and running represented by the current behavior information is changed into the predictive behavior of the predicted pedestrian P corresponding to one of stopping, walking and running represented by the predictive behavior information.

The behavior change prediction information may include information about the current behavior of the predicted pedestrian P and the predictive behavior of the predicted pedestrian P.

The behavior predictor 350 can determine the need for vehicle control based on the behavior change prediction information and the vehicle driving information (1270).

The behavior predictor 350 may predict whether the predicted pedestrian P will enter the driving road on which the vehicle 1 drives based on the behavior change prediction information.

In particular, the behavior predictor 350 may identify whether the current operation of the predicted pedestrian P is one of stopping, walking and running based on the behavior change prediction information, and whether the predictive behavior of the predicted pedestrian P is one of stopping, walking and running.

In addition, the behavior predictor 350 may obtain the driving information of the vehicle 1 from the driving information obtaining device 370. The behavior predictor 350 may predict the possibility of collision between the vehicle 1 and the predicted pedestrian P based on the driving information when the predicted pedestrian P is predicted to enter the driving road on which the vehicle 1 drives.

The vehicle driving information may include the driving speed of the vehicle 1, whether it is accelerated or decelerated, and the like.

When it is determined that the vehicle 1 will proceed to the point where the predicted pedestrian P is positioned at the time when the predicted pedestrian P is predicted to enter the driving road based on the driving information, the behavior predictor 350 may predict that there is a possibility of collision between the vehicle 1 and the predicted pedestrian P.

The behavior predictor 350 may determine that there is need for vehicle control when it is predicted that there is a possibility of collision between the vehicle 1 and the predicted pedestrian P. In addition, the behavior predictor 350 may determine that there is no need for vehicle control when it is predicted that there is no possibility of collision between the vehicle 1 and the predicted pedestrian P and that the predicted pedestrian P predicts that the vehicle 1 will not enter the driving road on which the vehicle 1 drives.

When there is no need for the vehicle control (NO in 1280), the behavior predictor 350 may terminate the procedure without controlling the vehicle.

When there is need for the vehicle control (YES in 1280), the behavior predictor 350 may transmit the vehicle control signal (1290).

The behavior predictor 350 may generate the vehicle control signal for controlling the vehicle 1 when the possibility of collision between the vehicle 1 and the predicted pedestrian P is predicted and transmit the vehicle control signal to the vehicle controller 380.

The vehicle control signal may include a braking control signal for controlling the brake so that the vehicle 1 can stop or decelerate. In addition, the vehicle control signal may include a steering control signal for controlling the vehicle steering system so that the vehicle 1 can change lanes to avoid collision with the predicted pedestrian P. The vehicle control signal may also include a warning control signal for controlling the speaker 321, the display 322 and the HUD 323 to warn the driver of the vehicle 1 that the predicted pedestrian P is predicted to enter the driving road.

The behavior predictor 350 may transmit the vehicle control signal to the vehicle controller 380 to control the vehicle 1. Thereby, the vehicle 1 may stop or decelerate to avoid collision with the predicted pedestrian P, and may warn the driver in the vehicle 1 that the predicted pedestrian P entered the driving road.

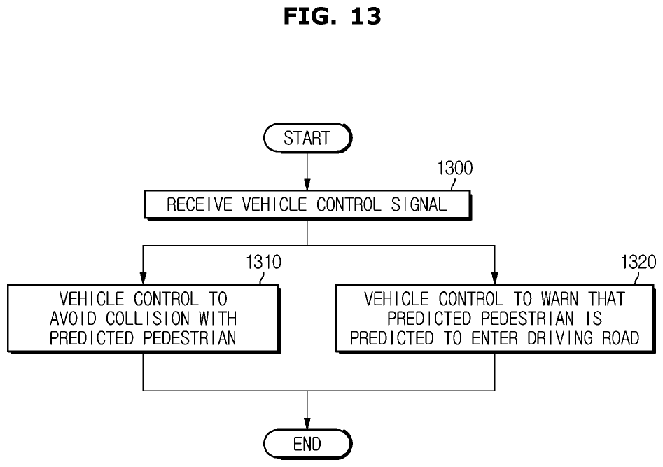

FIG. 13 is a flowchart illustrating a method for controlling a vehicle based on a vehicle control signal in a vehicle control method according to an embodiment.

Referring to FIG. 13, the vehicle controller 380 may receive the vehicle control signal (1300).

The vehicle controller 380 may receive the vehicle control signal transmitted by the behavior predictor 350.

The vehicle controller 380 may control the vehicle 1 to avoid collision with the predicted pedestrian P (1310).

The vehicle controller 380 may control the vehicle 1 to avoid collision with the predicted pedestrian P based on the vehicle control signal. In particular, the vehicle controller 380 may control the brake so that the vehicle 1 stops or decelerates based on the braking control signal of the vehicle control signal. Thereby, the vehicle 1 may stop or decelerate to avoid collision with the predicted pedestrian P.

Further, the vehicle controller 380 may control the vehicle steering apparatus so that the vehicle 1 changes the lane based on the steering control signal of the vehicle control signal. Thereby, the vehicle 1 may change the lane to avoid collision with the predicted pedestrian P.

Accordingly, the vehicle 1 may determine whether the predicted pedestrian P will enter the driving road in advance to prevent collision between the vehicle 1 and the predicted pedestrian P that may occur due to the driver's determination error or braking distance shortage.

The vehicle controller 380 may control the vehicle 1 to warn that the predicted pedestrian P is predicted to enter the driving road (1320).

The vehicle controller 380 may receive the vehicle control signal transmitted by the behavior predictor 350 and control the speaker 321 to warn that the predicted pedestrian P is predicted to enter the driving road based on the warning control signal of the vehicle control signal. Thereby, the speaker 321 may warn that the predicted pedestrian P is predicted to enter the driving road.

The vehicle controller 380 may also receive the vehicle control signal transmitted by the behavior predictor 350 and provide the display 322 to warn that the predicted pedestrian P is predicted to enter the driving road based on the warning control signal of the vehicle control signal. Thereby, the display 322 may warn that the predicted pedestrian P is predicted to enter the driving road. For example, the display 322 may display the warning indicating that the predicted pedestrian P is predicted to enter the driving road.

The vehicle controller 380 may also receive the vehicle control signal transmitted by the behavior predictor 350 and control the HUD 323 to warn that the predicted pedestrian P is predicted to enter the driving road based on the warning control signal of the vehicle control signal. Thereby, the HUD 323 may display on the front window 19a the warning indicating that the predicted pedestrian P is predicted to enter the driving road.

For example, when the predicted pedestrian P is predicted to enter the driving road on which the vehicle 1 drives, the HUD 323 may display on the front window 19a the warning indicating that the predicted pedestrian P is predicted to enter the driving road as “pedestrian entry warning.”

Also, the HUD 323 may display the predictive behavior of the predicted pedestrian P. The HUD 323 may display the predicted posture and position of the predicted pedestrian P after the certain point in time from the current point of view based on the predictive behavior of the predicted pedestrian P.

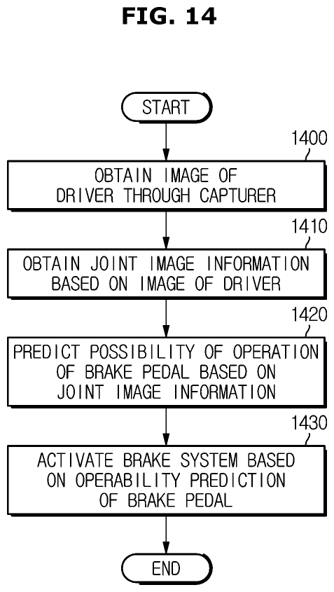

FIG. 14 is a flowchart illustrating a method for controlling a vehicle through behavior prediction of a driver in a vehicle control method according to an embodiment.

The driver may use the accelerator pedal 250 and the brake pedal 260 when the vehicle 1 is driving. Since the brake pedal 260 is associated with the braking function, the possibility of collision and the degree of damage at the time of collision may vary depending on the reaction speed of the brake system.

The vehicle 1 may predict the behavior of the driver in addition to the function of the vehicle 1 that can predict the behavior of the predicted pedestrian P and prevent collision between the vehicle 1 and the predicted pedestrian P and when the driver is predicted to operate the brake pedal 260, the reaction speed of the brake system may be controlled so that the brake system can be activated immediately before the brake pedal 260 is depressed.

Referring to FIG. 14, the behavior predictor 350 may obtain the image for the driver through the capturer 310 (1400).

The capturer 310 may capture the image of the driver in the vehicle 1 in real time and may transmit the image of the driver to the behavior predictor 350. Accordingly, the behavior predictor 350 may receive the image of the driver from the capturer 310.

The image of the driver described in the embodiment of the disclosure may include all the body parts of the driver. Hereinafter, the case where the image of the driver includes the foot of the driver will be described as an example.

The behavior predictor 350 may obtain the joint image information based on the image of the driver (1410).

The image processor 351 of the behavior predictor 350 may obtain the joint image information that is image information including the position of the driver's joints based on the image of the driver received from the capturer 310.

For example, the joint image information may be the skeleton model corresponding to the motion of the joints of the predicted pedestrian P. In particular, the joint image information may be determined as the feature point on the right ankle joint 563 and the right foot end 564 of the driver based on the image of the driver.

The behavior predictor 350 may predict the possibility of operation of the brake pedal based on the joint image information (1420).

The behavior predictor 350 may obtain the current behavior information of the driver based on the joint image information. The behavior predictor 350 may calculate the driver's foot direction and angle based on the feature points of the right ankle joint 563 and the right foot end 564 of the driver. Accordingly, the behavior predictor 350 may obtain the current behavior information indicating that the driver's current behavior corresponds to one of the accelerator pedal operation, the brake pedal operation, or the rest.

In addition, the behavior predictor 350 may obtain the predictive behavior information of the driver based on the joint image information.

The behavior prediction classifier 352 of the behavior predictor 350 may receive the change of characteristics of the right ankle joint 563 and the right foot end 564 of the driver and obtain the predictive behavior information indicating that the predictive behavior of the driver predicted based on the learning information received from the storage 390 is one of the accelerator pedal operation, the brake pedal operation, or the rest.

The learning information used for predicting the behavior of the driver may be generated by the learning machine 360 and stored in the storage 390.

In particular, the learning machine 360 may learn the driver's next behavior according to the change of each joint characteristic of the driver using the machine learning algorithm. That is, the learning machine 360 may learn the driver's next behavior according to the change of the characteristics of the right ankle joint 563 and the right foot end 564, and generate the learning information that can predict the driver's next behavior according to the change of the characteristics of the right ankle joint 563 and the right foot end 564 of the driver.

When the driver's next behavior is the accelerator pedal operation, the learning machine 360 may match the learning information indicating that the change of the characteristics of the right ankle joint 563 and the right foot end 564 when the driver's behavior changes to the accelerator pedal operation and the driver's next behavior corresponds to the accelerator pedal operation. When the driver's next behavior is the rest, the learning machine 360 may match the learning information indicating that the change of the characteristics of the right ankle joint 563 and the right foot end 564 when the driver's behavior changes to the rest and the driver's next behavior corresponds to the rest. When the driver's next behavior is the brake pedal operation, the learning machine 360 may match the learning information indicating that the change of the characteristics of the right ankle joint 563 and the right foot end 564 when the driver's behavior changes to the brake pedal operation and the driver's next behavior corresponds to the brake pedal operation.

The learning machine 360 may store the learning information indicating the driver's next behavior according to the change of each joint characteristic of the driver in the storage 390.

The behavior prediction classifier 352 of the behavior predictor 350 may detect that the change of each joint characteristic of the driver recognized based on the learning information corresponds to the change in the joint characteristics when the driver's next behavior is one of the accelerator pedal operation, the rest, or the brake pedal operation. Based on the driver's next behavior prediction of the behavior prediction classifier 352, the behavior predictor 350 may obtain the predictive behavior information indicating the predictive behavior of the predicted driver.

The behavior predictor 350 may obtain the behavior change prediction information by comparing the current behavior information and the predictive behavior information. The behavior predictor 350 may obtain the current behavior information indicating the driver's current behavior and the predictive behavior information indicating the driver's predictive behavior based on the joint image information.

The behavior predictor 350 may obtain the behavior change prediction information indicating the change in the behavior of the driver that changes from the current behavior to the predictive behavior by comparing the current behavior information and the predictive behavior information.

The behavior predictor 350 may predict the possibility of operation of the driver's brake pedal based on the behavior change prediction information. In particular, the behavior predictor 350 may predict that the driver's behavior will change from the current behavior, which is the accelerator pedal operation or the rest, to the predictive behavior, which is the brake pedal operation, based on the behavior change prediction information.

The behavior predictor 350 may activate the brake system based on the brake pedal operability prediction (1430).

The behavior predictor 350 may activate the brake system when predicting that the driver's behavior will change from the current behavior, which is the accelerator pedal operation or the rest, to the predictive behavior, which is the brake pedal operation, based on the behavior change prediction information.

In particular, the behavior predictor 350 may output the vehicle control signal to enable the vehicle controller 380 to activate the brake system when it is predicted that the driver's behavior will change to the brake pedal operation.

The brake system may be activated under the control of the vehicle controller 380, so that it can prepare the brake operation so that the vehicle 1 can brake immediately when the driver operates the brake pedal 260.

That is, the behavior predictor 350 may control the brake system so that the brake can be operated simultaneously with the operation of the brake pedal 260 of the driver.

As is apparent from the above description, the embodiments of the present disclosure may prevent a collision between the vehicle and the pedestrian by predicting the behavior of the driver and the pedestrian and controlling the vehicle based on the predicted behavior of the driver and the pedestrian, and may effectively control the vehicle while driving according to the collision prediction situation.

Meanwhile, the embodiments of the present disclosure may be implemented in the form of recording media for storing instructions to be carried out by a computer. The instructions may be stored in the form of program codes, and when executed by a processor, may generate program modules to perform an operation in the embodiments of the present disclosure. The recording media may correspond to computer-readable recording media.

The computer-readable recording medium includes any type of recording medium having data stored thereon that may be thereafter read by a computer. For example, it may be a ROM, a RAM, a magnetic tape, a magnetic disk, a flash memory, an optical data storage device, etc.

The exemplary embodiments of the present disclosure have thus far been described with reference to accompanying drawings. It will be obvious to those of ordinary skill in the art that the present disclosure may be practiced in other forms than the exemplary embodiments as described above without changing the technical idea or essential features of the present disclosure. The above exemplary embodiments are only by way of example, and should not be interpreted in a limited sense.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A vehicle comprising:
a capturer configured to capture an image around the vehicle;
a behavior predictor configured to:
obtain joint image information corresponding to joint motions of a pedestrian based on the captured image around the vehicle;
predict behavior change of the pedestrian based on the joint image information; and
determine a possibility of collision with the pedestrian based on the behavior change of the pedestrian; and
a vehicle controller configured to control at least one of stopping, decelerating or lane changing of the vehicle to avoid collision with the pedestrian when there is the possibility of collision with the pedestrian.

2. The vehicle according to claim 1, wherein the capturer is configured to capture a three-dimensional (3D) vehicle periphery image.

3. The vehicle according to claim 1, wherein the behavior predictor is configured to transmit a vehicle control signal to the vehicle controller when there is the possibility of collision with the pedestrian.

4. The vehicle according to claim 1, wherein the vehicle further comprises:
a situation recognizer configured to:
recognize a surrounding situation of the vehicle based on the image around the vehicle;
determine whether the pedestrian is possibly in a view based on the surrounding situation of the vehicle; and
output a trigger signal so that the behavior predictor obtains the joint image information when the pedestrian is in the view.

5. The vehicle according to claim 1, wherein the behavior predictor is configured to:
obtain the joint image information based on an image of the pedestrian of a plurality of pedestrians located closest to a driving road of the vehicle when the plurality of pedestrians are in a vehicle periphery image.

6. The vehicle according to claim 1, wherein the joint image information comprises lower body image information about a lower body of the pedestrian, and
wherein the behavior predictor is configured to predict the behavior change of the pedestrian based on the lower body image information.

7. The vehicle according to claim 1, wherein the vehicle further comprises:
a learning machine configured to:
learn a next behavior of the pedestrian in a previous driving corresponding to a change of the joint features of the pedestrian in the previous driving using a machine learning algorithm; and
generate learning information configured to predict the next behavior of the pedestrian based on the change of the joint features of the pedestrian,
wherein the joint features of the pedestrian comprises at least one of an angle of joints or a position of the joints.

8. The vehicle according to claim 7, wherein the behavior predictor is configured to:
calculate the joint features of the pedestrian based on the joint image information; and
obtain current behavior information indicating a current behavior of the pedestrian based on the joint features of the pedestrian.

9. The vehicle according to claim 8, wherein the behavior predictor is configured to:
calculate a change of the joint features of the pedestrian based on the joint image information; and
obtain predictive behavior information indicating a predicted next behavior of the pedestrian after a certain amount of time based on the change of the joint features of the pedestrian and the learning information.

10. The vehicle according to claim 9, wherein the behavior predictor is configured to:
obtain behavior change prediction information indicating the behavior change of the pedestrian by comparing the current behavior information and the predictive behavior information.

11. The vehicle according to claim 10, wherein the behavior predictor is configured to:
predict whether the pedestrian enters the driving road of the vehicle based on the behavior change prediction information; and
determine the possibility of collision with the pedestrian based on the vehicle driving information when the pedestrian is predicted to enter the driving road of the vehicle,
wherein the vehicle driving information comprises at least one of a driving speed, an acceleration state, or a deceleration state.

12. The vehicle according to claim 11, wherein the vehicle further comprises:
a speaker configured to output, to the driver of the vehicle, at least one of a warning sound or a voice guidance indicating that the pedestrian is predicted to enter the driving road of the vehicle.

13. The vehicle according to claim 11, wherein the vehicle further comprises:
a display configured to display, to the driver of the vehicle, a warning indicating that the pedestrian is predicted to enter the driving road of the vehicle.

14. The vehicle according to claim 11, wherein the vehicle further comprises:
a Head Up Display (HUD) configured to display on a windshield of the vehicle at least one of the warning indicating that the pedestrian is predicted to enter the driving road or a silhouette of the pedestrian,
wherein the silhouette of the pedestrian corresponds to the predicted next behavior of the pedestrian after the certain amount of time.

15. The vehicle according to claim 14, wherein the HUD is configured to display a plurality of silhouettes of the pedestrian on the windshield of the vehicle,
wherein each silhouette of the plurality of silhouettes corresponds to the predicted next behavior of the pedestrian after the certain amount of time.

16. A vehicle comprising:
a capturer configured to capture an in-vehicle image;
a behavior predictor configured to:
obtain joint image information corresponding to joint motions of a driver based on the captured in-vehicle image;
predict behavior change of the driver based on the joint image information; and
determine a possibility of brake operation of the driver based on the behavior change of the driver; and
a vehicle controller configured to control a brake system so that a brake can be operated corresponding to the brake operation of the driver when there is the possibility of the brake operation of the driver.

17. The vehicle according to claim 16, wherein the behavior predictor is configured to:
calculate joint features of the driver and a change of the joint features based on the joint image information;
obtain current behavior information indicating a current behavior of the driver based on the joint features of the driver; and
obtain predictive behavior information indicating a predicted next behavior of the driver after a certain amount of time based on the change of the joint features and learning information that is configured to predict a next behavior of the driver based on the change of the joint features.

18. The vehicle according to claim 17, wherein the behavior predictor is configured to:
obtain behavior change prediction information indicating the behavior change of the driver by comparing the current behavior information and the predictive behavior information; and
determine the possibility of the brake operation of the driver based on the behavior change prediction information.

19. A method for controlling a vehicle comprising:
capturing an image around the vehicle;
obtaining joint image information corresponding to joint motions of a pedestrian based on the captured image around the vehicle;
predicting behavior change of the pedestrian based on the joint image information;
determining a possibility of collision with the pedestrian based on the behavior change of the pedestrian; and
controlling at least one of stopping, decelerating or lane changing of the vehicle to avoid collision with the pedestrian when there is the possibility of collision with the pedestrian.

20. The method according to claim 19, wherein capturing the image around the vehicle comprises:
capturing a three-dimensional (3D) vehicle periphery image.

21. The method according to claim 19, wherein the method further comprises:
recognizing a surrounding situation of the vehicle based on the image around the vehicle;
determining whether the pedestrian is possibly in a view based on the surrounding situation of the vehicle; and
outputting a trigger signal to obtain the joint image information when the pedestrian is in the view.

22. The method according to claim 19, wherein the method further comprises:
obtaining the joint image information based on an image of the pedestrian of a plurality of pedestrians located closest to a driving road of the vehicle when the plurality of pedestrians are in a vehicle periphery image.

23. The method according to claim 19, wherein the method further comprises:
predicting the behavior change of the pedestrian based on lower body image information, wherein the joint image information comprises lower body image information about a lower body of the pedestrian.

24. The method according to claim 19, wherein the method further comprises:
learning a next behavior of the pedestrian in a previous driving corresponding to a change of the joint features of the pedestrian in the previous driving using a machine learning algorithm; and
generating learning information configured to predict the next behavior of the pedestrian based on the change of the joint features of the pedestrian,
wherein the joint features of the pedestrian comprises at least one of an angle of joints or a position of the joints.

25. The method according to claim 24, wherein the method further comprises:
calculating the joint features of the pedestrian based on the joint image information; and
obtaining current behavior information indicating a current behavior of the pedestrian based on the joint features of the pedestrian.

26. The method according to claim 25, wherein the method further comprises:
calculating a change of the joint features of the pedestrian based on the joint image information; and
obtaining predictive behavior information indicating a predicted next behavior of the pedestrian after a certain amount of time based on the change of the joint features and the learning information.

27. The method according to claim 26, wherein the method further comprises:
obtaining behavior change prediction information indicating the behavior change of the pedestrian by comparing the current behavior information and the predictive behavior information.

28. The method according to claim 27, wherein the method further comprises:
predicting whether the pedestrian enters the driving road of the vehicle based on the behavior change prediction information; and
determining the possibility of collision with the pedestrian based on the vehicle driving information when the pedestrian is predicted to enter the driving road of the vehicle,
wherein the vehicle driving information comprises at least one of a driving speed, an acceleration state, or a deceleration state.

29. The method according to claim 28, wherein the method further comprises:
outputting, to the driver of the vehicle, at least one of a warning sound or a voice guidance indicating that the pedestrian is predicted to enter the driving road of the vehicle.

30. The method according to claim 28, wherein the method further comprises:
displaying, to the driver of the vehicle, a warning indicating that the pedestrian is predicted to enter the driving road of the vehicle.

31. The method according to claim 28, wherein the method further comprises:
displaying on a windshield of the vehicle at least one of the warning indicating that the pedestrian is predicted to enter the driving road or a silhouette of the pedestrian,
wherein the silhouette of the pedestrian corresponds to the predicted next behavior of the pedestrian after the certain amount of time.

32. The method according to claim 31, wherein the method further comprises:
displaying a plurality of silhouettes on the windshield of the vehicle,
wherein each silhouette of the plurality of silhouettes corresponds to the predicted next behavior of the pedestrian after the certain amount of time.

33. A method for controlling a vehicle comprising:
capturing an in-vehicle image;
obtaining joint image information corresponding to joint motions of a driver based on the captured in-vehicle image;
predicting behavior change of the driver based on the joint image information;
determining a possibility of brake operation of the driver based on the behavior change of the driver; and
controlling a brake system so that a brake can be operated corresponding to the brake operation of the driver when there is the possibility of the brake operation of the driver.

34. The method according to claim 33, wherein the method further comprises:
calculating joint features of the driver and a change of the joint features based on the joint image information;
obtaining current behavior information indicating a current behavior of the driver based on the joint features; and
obtaining predictive behavior information indicating a predicted next behavior of the driver after a certain amount of time based on the change of the joint features and learning information that is configured to predict a next behavior of the driver based on the change of the joint features.

35. The method according to claim 34, wherein the method further comprises:
obtaining behavior change prediction information indicating the behavior change of the driver by comparing the current behavior information and the predictive behavior information; and
determining the possibility of the brake operation of the driver based on the behavior change prediction information.
